(19) United States
(12) Patent Application Publication
(10) Pub. No.: US 2024/0315244 A1
(43) Pub. Date: Sep. 26, 2024

(54) ANTIVIRAL COATING AGENT, ANTIVIRAL AGENT, LAMINATED BODY, AND PACKAGE OR CONTAINER

(71) Applicants: National Institute for Materials Science, Tsukuba-shi, Ibaraki (JP); DIC Corporation, Tokyo (JP)

(72) Inventors: Masanobu Naito, Tsukuba-shi (JP); Takehiro Fujita, Tsukuba-shi (JP); Shin-ichi Ohara, Tokyo (JP); Hiroki Kobayashi, Tokyo (JP); Tatsuya Kouyama, Tokyo (JP); Takashi Tamaoka, Tokyo (JP)

(73) Assignees: National Institute for Materials Science, Tsukuba-shi, Ibaraki (JP); DIC Corporation, Tokyo (JP)

(21) Appl. No.: 18/577,828

(22) PCT Filed: Jul. 1, 2022
(86) PCT No.: PCT/JP2022/026495

§ 371 Date: Jan. 9, 2024

(30) Foreign Application Priority Data
Jul. 16, 2021 (JP) 2021-117575

(51) Int. Cl. A01N 43/16; A01P 1/00; B65D 65/42; B65D 81/24; C09D 5/14; C09D 7/63; C09D 167/00

(52) U.S. Cl. CPC A01N 43/16; B65D 65/42; B65D 81/24; C09D 5/14; C09D 7/63; C09D 167/00; A01P 1/00

(57) ABSTRACT

An antiviral coating agent includes a tannic acid derivative including at least one organic group having 1 to 18 carbon atoms and a binder resin having a number-average molecular weight of 1,000 or more. The average number of the organic groups included in a molecule of the tannic acid derivative is, for example, 1 to 19.

### TECHNICAL FIELD

The present invention relates to an antiviral coating agent, an antiviral agent, a laminated body, and a package or container that includes the laminated body.

The present application is based on and claims a priority to Japanese Patent Application No. 2021-117575 filed on Jul. 16, 2021, which is incorporated herein by reference in its entirety.

### BACKGROUND ART

A silver ion and a copper (II) ion have been used as an active component for antiviral materials. Various antiviral materials including the above metal ions that are deposited on a substance, such as zeolite or silica gel, or that are dispersed in a solvent have been proposed.

For example, in PTL 1, it is described that an antiviral agent that includes specific metal copper microparticles as an active component has an antiviral property against viruses having an envelope structure, such as an influenza virus, and viruses that do not have an envelope structure, such as norovirus.

In PTL 2, an anti-norovirus agent that includes an extract of a persimmon plant, which contains tannin, and that is markedly effective to norovirus and highly harmless to human bodies is described as an antiviral agent highly harmless to human bodies. In PTL 3, an antiviral agent that includes an extract of a persimmon plant, a catechin, wattle tannin, pentagalloyl glucose, coffee tannin, pyrogallol, gallic acid, nutgall tannin, or the like, which contains tannin, as an active component and that are markedly effective to envelope viruses (e.g., human or cattle pathogenic viruses, such as a human influenza virus, an avian influenza virus, herpes simplex virus type 1, Newcastle disease virus, and vesicular stomatitis virus, and fish disease viruses, such as viral haemorrhagic septicaemia virus) and highly harmless to human bodies are described.

### CITATION LIST

### Patent Literature

PTL 1: Japanese Unexamined Patent Application Publication No. 2019-064979
PTL 2: International Publication No. 2008/153077
PTL 3: International Publication No. 2010/067869

### SUMMARY OF INVENTION

### Technical Problem

It is difficult to directly apply the antiviral agent described in PTL 1, which includes a metal copper as an active component, to food packaging materials or the like which may come into direct contact to foods or the like.

As for the antiviral agents described in PTLs 2 and 3, it takes about one or more years to produce the extract (see Example 1, etc.). Furthermore, it is difficult to produce the extract in an industrially stable manner because particles of an immature fruit of persimmon (astringent persimmon), which is a natural product, are used. Moreover, since the antiviral agents described in PTLs 2 and 3 are aqueous solutions of organic compounds, it is difficult to add them to a coating agent or the like that includes an organic solvent as a medium. It is also difficult to use the antiviral agents as an in-line coating agent for food packaging materials or the like.

An object of the present invention is to provide an antiviral coating agent, an antiviral agent, a laminated body, and a package or container that can be produced in an industrially stable manner and that can be used for food packaging materials.

### Solution to Problem

The inventors of the present invention conducted extensive studies in order to achieve the above object and consequently found that, when an antiviral coating agent includes a tannic acid derivative including at least one organic group having 1 to 18 carbon atoms and a binder resin having a number-average molecular weight of 1,000 or more, the organic group allows antiviral activity to be readily produced, the binder resin causes the tannic acid derivative to be fixed in the resin in a stable manner, and a suitable antiviral property can be produced consequently. It was also found that, when a tannic acid derivative including an acryloyl group is used as an antiviral agent, the acryloyl group causes an excellent antiviral property against viruses that do not have an envelope structure to be produced. It was further found that it is possible to produce an antiviral coating agent or antiviral agent including the tannic acid derivative in an industrially stable manner since the tannic acid derivative hardly adversely affect human bodies, therefore can be applied directly to a coating agent or the like for food packaging materials, and can be readily synthesized using tannic acid, which can be produced industrially, as a starting material.

Specifically, the present invention provides the following structures.

[1] An antiviral coating agent including a tannic acid derivative including at least one organic group having 1 to 18 carbon atoms, and a binder resin having a number-average molecular weight of 1,000 or more.

[2] The antiviral coating agent according to [1], wherein the organic group has one or more structures selected from the group consisting of a group having an unsaturated double bond between carbon atoms, a group having an unsaturated double bond between oxygen and carbon atoms, and an alkyl group.

[3] The antiviral coating agent according to [1] or [2], wherein an average number of the organic groups included in a molecule of the tannic acid derivative is 1 to 38.

[4] The antiviral coating agent according to any one of [1] to [3], represented by Formula (1) below.

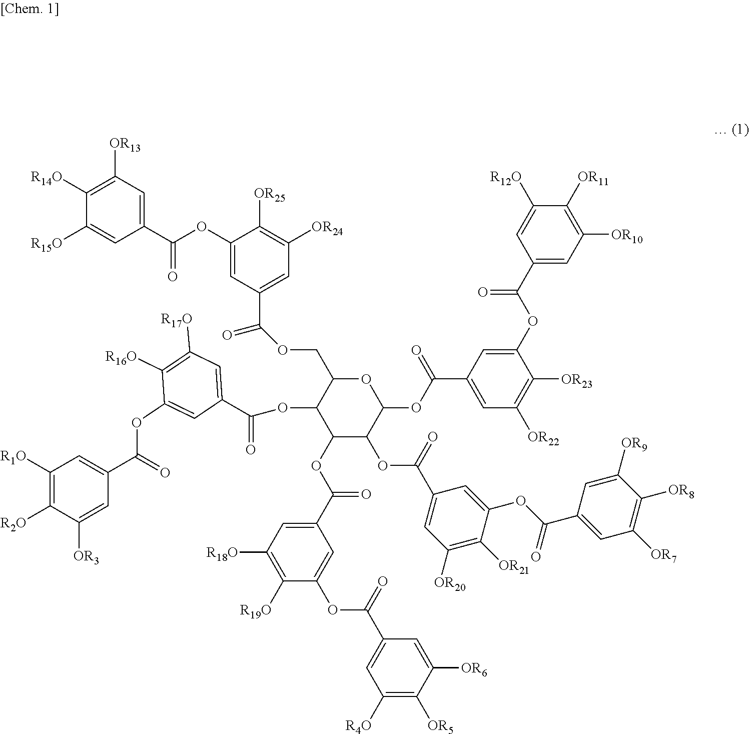

{In General Formula (1), R₁ to R₂₅ each independently represent (excluding the case where R₁ to R₂₅ all represent a hydrogen atom) a group selected from the group consisting of a hydrogen atom, —C(═O)—CH═CH₂, —C(═O)—C(CH₃)═CH₂, —C(═O)N—CH═CH₂, —C(═O)N—C(CH₃)═CH₂, —C(—OH)—CH═CH₂, —C(—OH)—C(CH₃)═CH₂, —C(═O)N—(CH₂)₂—CH═CH₂, —C(═O)N—(CH₂)₂—C(CH₃)═CH₂, —C((═O)N—C((CH₂)₂—CH═CH₂)═₂, —C(═O)—R₂₆, and —R₂₆ (where R₂₆ represents a hydrocarbon having 1 to 18 carbon atoms)}

[5] A laminated body including a substrate and a coat layer including the antiviral coating agent according to any one of [1] to [4].

[6] The laminated body according to [5], wherein the coat layer serves as a decorating layer.

[7] The laminated body according to [6], wherein the decorating layer includes a print layer including a printing ink.

[8] The laminated body according to [5], wherein the coat layer is a layer formed of a coating agent having a sealing property.

[9] The laminated body according to [5], further including a sealing layer disposed on a side of the substrate, the side being opposite to a side on which the coat layer is disposed,
wherein the sealing layer includes a tannic acid derivative including at least one organic group having 1 to 18 carbon atoms.

[10] The laminated body according to [9], wherein the sealing layer includes the tannic acid derivative and a binder resin.

[11] A package or container including a container main body and one or more laminated bodies according to any one of [5] to [10], the one or more laminated bodies being attached to the container main body.

[12] The package or container according to [11], wherein the laminated body serves as a lid for the container main body.

[13] The package or container according to [11], wherein the laminated body is attached onto an outer surface of the container main body.

[14] A package or container including a housing including one or more laminated bodies according to any one of [5] to [10], the one or more laminated bodies being bonded to one another, and an accommodation formed inside the housing.

[15] An antiviral agent including a tannic acid derivative including at least one acryloyl group.

[16] The antiviral agent according to [15], capable of inactivating a virus that does not have an envelope structure.

### Advantageous Effects of Invention

According to the present invention, an antiviral coating agent, an antiviral agent, a laminated body, and a package or container that can be produced in an industrially stable manner and that can be used for food packaging materials can be provided.

### BRIEF DESCRIPTION OF DRAWINGS

FIG. 1 is a chemical reaction flowchart illustrating an example of derivatization of tannic acid which is performed in a method for producing a tannic acid derivative included in an antiviral coating agent according to this embodiment.

FIG. 2A is a cross-sectional view of a laminated body according to an embodiment of the present invention, illustrating an example of the specific structure of the laminated body.

FIG. 2B is a cross-sectional view of the laminated body according to this embodiment, illustrating another example of the specific structure of the laminated body.

FIG. 3A is a cross-sectional view of a package including the laminated body according to this embodiment, illustrating an example of the specific structure of the package.

FIG. 3B is a perspective of a container including the laminated body according to this embodiment, illustrating an example of the specific structure of the container.

FIG. 4 is a perspective view of the package including the laminated body according to this embodiment, illustrating another example of the specific structure of the package.

FIG. 5A is a perspective view of the package including the laminated body according to this embodiment, illustrating another example of the specific structure of the package.

FIG. 5B is a cross-sectional view taken along Line I-I of FIG. 5A.

FIG. 6 is a perspective view of the container including the laminated body according to this embodiment, illustrating another example of the specific structure of the container.

### DESCRIPTION OF EMBODIMENTS

Details of embodiments of the present invention are described with reference to the attached drawings below. It should be noted that the present invention is not limited by the following embodiments.

### <Coating Agent>

The antiviral coating agent according to this embodiment includes a tannic acid derivative including at least one organic group having 1 to 18 carbon atoms and a binder resin having a number-average molecular weight of 1,000 or more. Hereinafter, in this embodiment, the tannic acid derivative included in the antiviral coating agent is also referred to as “tannic acid derivative A”. In this embodiment, for the sake of simple explanation, the tannic acid derivative included in the antiviral coating agent is referred to as “tannic acid derivative A”, while the tannic acid derivative included in the antiviral agent described below is referred to as “tannic acid derivative B”. The tannic acid derivative A may include the tannic acid derivative B.

### (Tannic Acid Derivative A)

The tannic acid derivative A included in the antiviral coating agent is a tannic acid derivative in which at least a part of the plurality of hydroxyl groups are replaced with a group having a carbon atom. The tannic acid derivative A includes at least one organic group having 1 to 18 carbon atoms per molecule. Since tannic acid has polarity, it does not exhibit activity when included in the coating agent as a component. Since tannic acid is soluble in polar solvents, such as N-propionyl morpholine (NPM) and methyl ethyl ketone (MEK), but insoluble in low-polarity solvents, such as ethyl acetate, tannic acid does not rise to the surface of a coating film formed of the coating agent and is unlikely to exhibit an antiviral property. In contrast, when at least a part of the plurality of hydroxyl groups are replaced with a group including an organic group having 1 to 18 carbon atoms as in the tannic acid derivative A, solubility in low-polarity solvents is enhanced and the tannic acid derivative A is likely to rise to the surface of a coating film formed of the coating agent and exhibits an antiviral property.

The organic group having 1 to 18 carbon atoms is not limited and preferably includes one or more structures selected from the group consisting of a group having an unsaturated double bond between carbon atoms, a group having an unsaturated double bond between oxygen and carbon atoms, and an alkyl group in order to further enhance virus inactivation. The group having an unsaturated double bond between oxygen and carbon atoms is, for example, a carbonyl group.

Among these, the organic group preferably includes either or both of the group having an unsaturated double bond between carbon atoms and the group having an unsaturated double bond between oxygen and carbon atoms. Examples of such an organic group include an acryloyl group, a methacryloyl group, an allyl group, a vinyl group, and an acetyl group.

The organic group may be a group including an unsaturated double bond derived from an unsaturated acid as a reaction product.

The above organic group is bonded to the tannic acid skeleton with a bond including an oxygen atom derived from a hydroxyl group.

In the case where the organic group has an unsaturated double bond, the number of unsaturated double bonds included in a molecule of the tannic acid derivative A is preferably 1 to 38, is more preferably 1 to 34, and is further preferably 1 to 19.

In the case where the organic group has an unsaturated double bond, only one unsaturated double bond may be attached to one substitution site. In another case, a plurality of unsaturated double bonds may be attached to one substitution site. Among a plurality of substitution sites of the tannic acid derivative, groups having an unsaturated double bond which are attached to the respective substitution sites may be identical to or different from one another.

In order to further enhance solubility in low-polarity solvents, the average number of the organic groups having 1 to 18 carbon atoms which are included in a molecule of the tannic acid derivative A is preferably 1 to 19.

The substitution ratio between tannic acid and the compound including at least one organic group having 1 to 18 carbon atoms is preferably Tannic acid:(Compound including at least one organic group having 1 to 18 carbon atoms)=1:1 to 1:19 by mole.

In the case where the organic group includes an unsaturated double bond, similarly, the substitution ratio (molar ratio) between tannic acid and a compound including an organic group having one or more unsaturated double bond groups is preferably, but not limited to, Tannic acid:(Compound including organic group having one or more unsaturated double bond groups)=1:1 to 1:19.

Specifically, the tannic acid derivative A is represented by, for example, Formula (1) below.

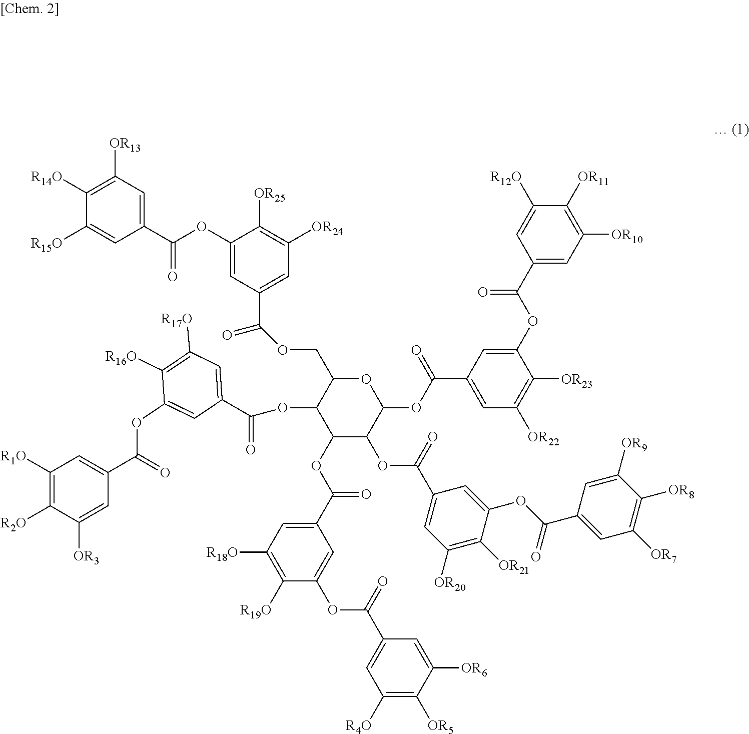

{In General Formula (1), R₁ to R₂₅ each independently represent (excluding the case where R₁ to R₂₅ all represent a hydrogen atom) a group selected from the group consisting of a hydrogen atom, —C(═O)—CH═CH₂, —C(═O)—C(CH₃)═CH₂, —C(═O)N—CH═CH₂, —C(═O)N—C(CH₃)═CH₂, —C(—OH)—CH═CH₂, —C(—OH)—C(CH₃)═CH₂, —C(═O)N—(CH₂)₂—CH═CH₂, —C(═O)N—(CH₂)₂—C(CH₃)═CH₂, —C((═O)N—C((CH₂)₂—CH═CH₂)₂, —C(═O)—R₂₆, and —R₂₆ (where R₂₆ represents a hydrocarbon having 1 to 18 carbon atoms)}

### (Binder Resin)

A binder resin is suitably used as a binder for antiviral coating agents used for paper, films, and the like which include organic solvents or the like as media. In order to fix the tannic acid derivative A in a further stable manner, the number-average molecular weight of the binder resin is preferably 500 or more and 100,000 or less and is more preferably 1,000 or more and 50,000 or less.

The type of the binder resin is not limited. The binder resin is, for example, at least one resin selected from the group consisting of a urethane resin, an acrylic resin, a vinyl chloride-vinyl acetate copolymer resin, a polyester resin, and an olefin resin.

### (A) Urethane Resin

The urethane resin is not limited and may be any polyurethane resin produced by the reaction of a polyol with a polyisocyanate. Examples of the polyol that can be used include various polyols publicly known and commonly used in the production of polyurethane resins. The polyols may be used alone or in combination of two or more. Examples of the polyols include saturated and unsaturated low-molecular-weight polyols (1), such as ethylene glycol, 1,2-propanediol, 1,3-propanediol, 2-methyl-1,3-propanediol, 2-ethyl-2-butyl-1,3-propanediol, 1,3-butanediol, 1,4-butanediol, neopentyl glycol, pentanediol, 3-methyl-1,5-pentanediol, hexanediol, octanediol, 1,4-butynediol, 1,4-butylene diol, diethylene glycol, triethylene glycol, dipropylene glycol, glycerine, trimethylolpropane, trimethylolethane, 1,2,6-hexanetriol, 1,2,4-butanetriol, sorbitol, and pentaerythritol; polyester polyols (2) produced by the dehydration condensation or polymerization of the above low-molecular-weight polyols (1) with polyvalent carboxylic acids, such as sebacic acid, adipic acid, phthalic acid, isophthalic acid, terephthalic acid, maleic acid, fumaric acid, succinic acid, oxalic acid, malonic acid, glutaric acid, pimelic acid, suberic acid, azelaic acid, trimellitic acid, and pyromellitic acid, or anhydrides thereof; polyester polyols (3) produced by the ring-opening polymerization of cyclic ester compounds or lactones, such as polycaprolactone, polyvalerolactone, and poly(β-methyl-γ-valerolactone); polycarbonate polyols (4) produced by the reaction of the low-molecular-weight polyols (1) or the like with dimethyl carbonate, diphenyl carbonate, ethylene carbonate, phosgene, or the like; polybutadiene glycols (5); glycols (6) produced by the addition of ethylene oxide or propylene oxide to bisphenol A; and acrylic polyols (7) produced by the copolymerization of one or more hydroxyethyl, hydroxypropyl acrylate, acryl hydroxybutyl, a methacrylic acid derivative corresponding to any of the above compounds, or the like per molecule with acrylic acid, methacrylic acid, an ester thereof, or the like.

Examples of the polyisocyanate include various aromatic diisocyanates, aliphatic diisocyanates, and alicyclic diisocyanates publicly known and commonly used in the production of polyurethane resins. Examples thereof include aromatic polyisocyanates, such as 1,3-phenylene diisocyanate, 1,4-phenylene diisocyanate, 1-methyl-2,4-phenylene diisocyanate, 1-methyl-2,6-phenylene diisocyanate, 1-methyl-2,5-phenylene diisocyanate, 1-methyl-2,6-phenylene diisocyanate, 1-methyl-3,5-phenylene diisocyanate, 1-ethyl-2,4-phenylene diisocyanate, 1-isopropyl-2,4-phenylene diisocyanate, 1,3-dimethyl-2,4-phenylene diisocyanate, 1,3-dimethyl-4,6-phenylene diisocyanate, 1,4-dimethyl-2,5-phenylene diisocyanate, diethylbenzene diisocyanate, diisopropylbenzene diisocyanate, 1-methyl-3,5-diethylbenzene diisocyanate, 3-methyl-1,5-diethylbenzene-2,4-diisocyanate, 1,3,5-triethylbenzene-2,4-diisocyanate, naphthalene-1,4-diisocyanate, naphthalene-1,5-diisocyanate, 1-methyl-naphthalene-1,5-diisocyanate, naphthalene-2,6-diisocyanate, naphthalene-2,7-diisocyanate, 1,1-dinaphthyl-2,2′-diisocyanate, biphenyl-2,4′-diisocyanate, biphenyl-4,4′-diisocyanate, 3-3′-dimethylbiphenyl-4,4′-diisocyanate, 4,4′-diphenylmethane diisocyanate, 2,2′-diphenylmethane diisocyanate, and diphenylmethane-2,4-diisocyanate; and aliphatic and alicyclic polyisocyanates, such as tetramethylene diisocyanate, hexamethylene diisocyanate, dodecamethylene diisocyanate, trimethylhexamethylene diisocyanate, 1,3-cyclopentylene diisocyanate, 1,3-cyclohexylene diisocyanate, 1,4-cyclohexylene diisocyanate, 1,3-di(isocyanatomethyl)cyclohexane, 1,4-di(isocyanatomethyl)cyclohexane, lysine diisocyanate, isophorone diisocyanate, 4,4′-dicyclohexylmethane diisocyanate, 2,4′-dicyclohexylmethane diisocyanate, 2,2′-dicyclohexylmethane diisocyanate, and 3,3′-dimethyl-4,4′-dicyclohexylmethane diisocyanate. The above polyisocyanates may be used alone or in combination of two or more. Among these, the above diisocyanate compounds may be used alone or in a mixture of two or more.

A chain extender may be used optionally. Examples of the chain extender include ethylenediamine, propylenediamine, hexamethylenediamine, diethylenetriamine, triethylenetetramine, isophoronediamine, and dicyclohexylmethane-4,4′-diamine. Examples of the chain extender also include amines having a hydroxyl group in the molecule, such as 2-hydroxyethylethylenediamine, 2-hydroxyethylpropyldiamine, 2-hydroxyethylpropylenediamine, di-2-hydroxyethylethylenediamine, di-2-hydroxyethylenediamine, di-2-hydroxyethylpropylenediamine, 2-hydroxypropylethylenediamine, di-2-hydroxypropylethylenediamine, and di-2-hydroxypropylethylenediamine. The above chain extenders may be used alone or in a mixture of two or more.

A monovalent active hydrogen compound may also be used as a terminal capping agent in order to terminate the reaction. Examples of such compounds include dialkylamines, such as di-n-butylamine, and alcohols, such as ethanol and isopropyl alcohol. In particular, in the case where a carboxyl group is to be introduced into the polyurethane resin, an amino acid, such as glycine or L-alanine, can be used as a reaction terminating agent. The above terminal capping agents may be used alone or in a mixture of two or more.

The number-average molecular weight of the urethane resin is preferably 1,000 or more and 100,000 or less and is more preferably 1,000 or more and 50,000 or less.

### (B) Acrylic Resin

The acrylic resin is not limited and may be any acrylic resin produced by copolymerization of polymerizable monomers including a (meth)acrylic acid ester as a principal component. Examples of the polymerizable monomers include methyl (meth)acrylate, ethyl (meth)acrylate, propyl (meth)acrylate, n-butyl (meth)acrylate, iso-butyl (meth)acrylate, 2-ethylhexyl (meth)acrylate, n-octyl (meth)acrylate, iso-octyl (meth)acrylate, lauryl (meth)acrylate, stearyl (meth)acrylate, iso-nonyl (meth)acrylate, cyclohexyl (meth)acrylate, benzyl (meth)acrylate, methoxyethyl (meth)acrylate, ethoxyethyl (meth)acrylate, and phenoxyethyl (meth)acrylate. The polymerization method is also not limited; acrylic resins produced by publicly known polymerization methods, such as bulk polymerization, solution polymerization, emulsion polymerization, and suspension polymerization, can be used.

The number-average molecular weight of the acrylic resin is preferably 1,000 or more and 100,000 or less and is more preferably 1,000 or more and 50,000 or less.

### (C) Vinyl Chloride-Vinyl Acetate Copolymer Resin

The vinyl chloride-vinyl acetate copolymer resin is not limited and may be any resin produced by copolymerization of vinyl chloride with vinyl acetate. The proportion of the structure derived from a vinyl acetate monomer is preferably 1% to 30% by mass and the proportion of the structure derived from a vinyl chloride monomer is preferably 70% to 95% by mass, with the solid content of the vinyl chloride-vinyl acetate copolymer resin being 100% by mass. In such a case, solubility in organic solvents can be enhanced. Furthermore, adhesion to substrates, the physical properties of the resulting coating film, scuff resistance, and the like can be improved.

A vinyl chloride-vinyl acetate copolymer resin including a hydroxyl group derived from a vinyl alcohol structure is also preferable in consideration of solubility in organic solvents. The hydroxyl value of the vinyl chloride-vinyl acetate copolymer resin is preferably 20 to 200 mgKOH/g. The glass transition temperature of the vinyl chloride-vinyl acetate copolymer resin is preferably 50° C. to 90° C.

The number-average molecular weight of the vinyl chloride-vinyl acetate copolymer resin is preferably 1,000 or more and 100,000 or less and is more preferably 1,000 or more and 50,000 or less.

### (D) Polyester Resin

The polyester resin is not limited and may be any polyester resin produced by a publicly known esterification polymerization reaction of an alcohol with a carboxylic acid.

Examples of the alcohol include ethylene glycol, 1,2-propanediol, 1,3-propanediol, 2-methyl-1,3-propanediol, 2-ethyl-2-butyl-1,3-propanediol, 1,3-butanediol, 1,4-butanediol, neopentyl glycol, 1,5-pentanediol, 1,2-pentanediol, 3-methyl-1,5-pentanediol, hexanediol, octanediol, 1,4-butynediol, 1,4-butylenediol, diethylene glycol, triethylene glycol, dipropylene glycol, glycerine, trimethylolpropane, trimethylolethane, 1,2,6-hexanetriol, 1,2,4-butanetriol, sorbitol, pentaerythritol, 1,4-cyclohexanediol, 1,2-cyclohexanediol, 1,4-cyclohexanedimethanol, 1,2-cyclohexanedimethanol, spiroglycol, and isosorbide. The above alcohols may be used alone or in a mixture of two or more. Among these, polyhydric alcohols are preferable.

Examples of the carboxylic acid include formic acid, acetic acid, propionic acid, butanoic acid, pentanoic acid, hexanoic acid, heptanoic acid, hexanoic acid, heptanoic acid, octanoic acid, nonanoic acid, decanoic acid, oleic acid, linolic acid, oxalic acid, malonic acid, succinic acid, glutaric acid, adipic acid, pimelic acid, suberic acid, azelaic acid, sebacic acid, phthalic acid, and 1,4-cyclohexanedicarboxylic acid. The above carboxylic acids may be used alone or in a mixture of two or more. Among these, polyfunctional carboxylic acids are preferable.

The number-average molecular weight of the polyester resin is preferably 500 or more and 10,000 or less and is more preferably 1,000 or more and 10,000 or less.

### (E) Olefin Resin

Examples of the olefin resin include polymers composed primarily of a hydrocarbon skeleton, such as a homopolymer or copolymer of olefin monomers, a copolymer of an olefin monomer with another monomer, hydrides or halides of the above polymers, and modified polymers produced by introducing functional groups, such as an acid and a hydroxyl group, to the above polymers. The above polymers may be used alone or in combination of two or more. It is preferable to use a crystalline olefin resin having an acid group or acid anhydride group or a crystalline olefin resin having a hydroxyl group.

Examples of the olefin resin having an acid group or acid anhydride group include an acid-modified olefin resin (E-1) that is a copolymer of an olefin monomer with an ethylenic unsaturated carboxylic acid or an ethylenic unsaturated carboxylic anhydride; and an acid-modified olefin resin (E-2) that is a resin produced by graft modification of a polyolefin with an ethylenic unsaturated carboxylic acid or an ethylenic unsaturated carboxylic anhydride.

Examples of the olefin monomer used for preparing the acid-modified olefin resin (E-1) include olefins having 2 to 8 carbon atoms, such as ethylene, propylene, isobutylene, 1-butene, 4-methyl-1-pentene, hexene, and vinylcyclohexane. Among these, olefins having 3 to 8 carbon atoms are preferable and propylene and 1-butene are more preferable in order to increase adhesive strength. It is particularly preferable to use propylene and 1-butene in combination in order to achieve excellent resistance to solvents and an excellent adhesive strength.

Examples of the ethylenic unsaturated carboxylic acid or ethylenic unsaturated carboxylic anhydride copolymerized with the above olefin monomer include acrylic acid, methacrylic acid, maleic acid, itaconic acid, citraconic acid, mesaconic acid, maleic anhydride, 4-methylcyclohex-4-ene-1,2-dicarboxylic anhydride, bicyclo[2.2.2]oct-5-ene-2,3-dicarboxylic anhydride, 1,2,3,4,5,8,9,10-octahydronaphthalene-2,3-dicarboxylic anhydride, 2-octa-1,3-diketospiro[4.4]non-7-ene, bicyclo[2.2.1]hept-5-ene-2,3-dicarboxylic anhydride, maleopimaric acid, tetrahydrophthalic anhydride, methyl-bicyclo[2.2.1]hept-5-ene-2,3-dicarboxylic anhydride, methyl-norborn-5-ene-2,3-dicarboxylic anhydride, and norborn-5-ene-2,3-dicarboxylic anhydride. Among these, maleic anhydride is preferable because it is excellent in terms of reactivity with the olefin monomer and the reactivity of the acid anhydride subsequent to copolymerization and the compound has a low molecular weight, which increases the concentration of functional groups in the resulting copolymer. The above compounds may be used alone or in combination of two or more.

In addition to the olefin monomer and the thylenic unsaturated carboxylic acid or ethylenic unsaturated carboxylic anhydride, another compound having an ethylenic unsaturated group, such as styrene, butadiene, or isoprene, may be used in combination for preparing the acid-modified olefin resin (E-1).

Examples of the polyolefin used for preparing the acid-modified olefin resin (E-2) include homopolymers and copolymers of olefins having 2 to 8 carbon atoms and copolymers of an olefin having 2 to 8 carbon atoms with another monomer. Specific examples thereof include polyethylene resins, such as high-density polyethylene (HDPE), low-density polyethylene (LDPE), and a linear low-density polyethylene resin; α-olefin copolymers, such as polypropylene, polyisobutylene, poly(1-butene), poly(4-methyl-1-pentene), polyvinylcyclohexane, an ethylene-propylene block copolymer, an ethylene-propylene random copolymer, an ethylene-1-butene copolymer, an ethylene-4-methyl-1-pentene copolymer, and an ethylene-hexene copolymer; and an ethylene-vinyl acetate copolymer, an ethylene-methyl methacrylate copolymer, an ethylene-vinyl acetate-methyl methacrylate copolymer, and a propylene-1-butene copolymer. Among these, in order to increase adhesive strength, a homopolymer of an olefin having 3 to 8 carbon atoms and a copolymer of two or more olefins having 3 to 8 carbon atoms are preferable, and a homopolymer of propylene and a propylene-1-butene copolymer are more preferable. A propylene-1-butene copolymer is particularly preferable because of excellent resistance to solvents and an excellent adhesive strength.

The ethylenic unsaturated carboxylic acid or ethylenic unsaturated carboxylic anhydride used for the graft modification of the polyolefin may be the same as that copolymerized with the olefin monomer in the preparation of the acid-modified olefin resin (E-1) described above. Maleic anhydride is preferable in order to enhance the reactivity of functional groups subsequent to graft modification and increase the concentration of functional groups of the graft-modified polyolefin. The above compounds may be used alone or in combination of two or more.

Specific examples of the method for reacting the polyolefin with the ethylenic unsaturated carboxylic acid or ethylenic unsaturated carboxylic anhydride using graft modification include a method of melting the polyolefin and adding the ethylenic unsaturated carboxylic acid or ethylenic unsaturated carboxylic anhydride (i.e., a graft monomer) to the molten polyolefin to cause a grafting reaction; a method of dissolving the polyolefin in a solvent and adding the ethylenic unsaturated carboxylic acid or ethylenic unsaturated carboxylic anhydride to the resulting solution to cause a grafting reaction; and a method of dissolving the polyolefin in an organic solvent, mixing the resulting solution with the ethylenic unsaturated carboxylic acid or ethylenic unsaturated carboxylic anhydride, and heating the resulting mixture at a temperature equal to or more than the softening or melting temperature of the polyolefin to perform radical polymerization and hydrogen abstraction simultaneously in a molten state.

In any of the above cases, it is preferable to perform the grafting reaction in the presence of a radical initiator in order to perform graft copolymerization of the graft monomers with efficiency. The grafting reaction is commonly performed at 60° C. to 350° C. The proportion of the radical initiator used is commonly 0.001 to 1 part by weight relative to 100 parts by weight of the polyolefin that has not been modified.

The radical initiator is preferably an organic peroxide. Examples thereof include benzoyl peroxide, dichlorobenzoyl peroxide, dicumyl peroxide, di-tert-butylperoxide, 2,5-dimethyl-2,5-di(peroxidebenzoate)hexyne-3, 1,4-bis(tert-butylperoxyisopropyl)benzene, lauroyl peroxide, tert-butyl peracetate, 2,5-dimethyl-2,5-di(tert-butylperoxy)hexyne-3, 2,5-dimethyl-2.5-di(tert-butylperoxy)hexane, tert-butyl perbenzoate, tert-butyl perphenylacetate, tert-butyl perisobutyrate, tert-butyl per-sec-octoate, tert-butyl perpivalate, cumyl perpivalate, and tert-butyl perdiethylacetate. Azo compound, such as azobisisobutyronitrile and dimethylazo isobutyrate, may also be used.

A radical initiator optimum for the process of the grafting reaction may be used. Commonly, a dialkyl peroxide, such as dicumyl peroxide, di-tert-butyl peroxide, 2,5-dimethyl-2,5-di(tert-butylperoxy)hexyne-3, 2,5-dimethyl-2,5-di(tert-butylperoxy)hexane, or 1,4-bis(tert-butylperoxyisopropyl)benzene, is preferably used.

In the case where the acid-modified olefin resin (E-1) or (E-2) is used as an olefin resin (E), it is preferable to use an acid-modified olefin resin (E-1) or (E-2) having an acid value of 1 to 200 mgKOH/g in order to further increase adhesion to metal layers and achieve excellent resistance to electrolytes.

Examples of the olefin resin (E-3) having a hydroxyl group include a copolymer of a polyolefin with a hydroxyl group-containing (meth)acrylic acid ester or hydroxyl group-containing vinyl ether; and a resin produced by graft modification of a polyolefin with a hydroxyl group-containing (meth)acrylic acid ester or hydroxyl group-containing vinyl ether. The polyolefin may be the same as that used in the preparation of the olefin resin (E-2). The modification method used may be the same as that used in the preparation of the acid-modified olefin resin (E-1) or (E-2).

Examples of the hydroxyl group-containing (meth)acrylic acid ester used for the modification include hydroxyethyl (meth)acrylate, hydroxypropyl (meth)acrylate, glycerol (meth)acrylate, lactone-modified hydroxyethyl (meth)acrylate, polyethylene glycol mono(meth)acrylate, and polypropylene glycol mono(meth)acrylate.

Examples of the hydroxyl group-containing vinyl ether include 2-hydroxyethyl vinyl ether, diethylene glycol monovinyl ether, and 4-hydroxybutyl vinyl ether.

In the case where the olefin resin (E-3) having a hydroxyl group is used as an olefin resin (E), it is preferable to use an olefin resin (E-3) having a hydroxyl value of 1 to 200 mgKOH/g in order to further increase adhesion to metal layers and achieve excellent resistance to electrolytes.

The polyolefin used for preparing the above-described acid-modified olefin resin (E-2) or the above-described olefin resin (E-3) having a hydroxyl group can be directly used as an olefin resin (E).

The number-average molecular weight of the olefin resin (E) is preferably 1,000 or more in order to enhance adhesiveness. The number-average molecular weight of the olefin resin (E) is preferably 10,000 or less in order to achieve adequate flowability.

The content of the tannic acid derivative in the antiviral coating agent is preferably 0.1% by mass or more and 50% by mass or less and is more preferably 0.5% by mass or more and 20% by mass or less.

The content of the binder resin in the antiviral coating agent is preferably 99.9% by mass or more and 50% by mass or less and is more preferably 99.5% by mass or more and 80% by mass or less.

The mass ratio between the tannic acid derivative and the binder resin included in the antiviral coating agent is preferably 0.1:99.9 to 50:50 and is more preferably 0.5:99.5 to 20:80.

### (Curing Agent)

In the case where the binder resin used in the present disclosure has a reactive group, such as a hydroxyl group, a carboxyl group, an amino group, or an epoxy group, a curing agent reactive with the reactive group may be used in combination. For example, an isocyanate-based curing agent, an epoxy-based curing agent, and an amino-based curing agent can be used.

The antiviral coating agent is preferably composed of an organic binder that includes the tannic acid derivative and the binder resin. Note that the term “organic binder” used herein refers to a binder that does not include or substantially does not include an inorganic substance such as a metal or an inorganic compound.

### (Solvent)

The antiviral coating agent may include a medium. A solvent such as an organic solvent can be used as a medium for the coating agent.

Examples of the solvent include, but are not limited to, aromatic hydrocarbon organic solvents, such as toluene, xylene, Solvesso #100, and Solvesso #150; aliphatic hydrocarbon organic solvents, such as hexane, methylcyclohexane, heptane, octane, and decane; and ester organic solvents, such as methyl acetate, ethyl acetate, isopropyl acetate, n-propyl acetate, butyl acetate, amyl acetate, ethyl formate, and butyl propionate. Examples of the solvent further include the following water-miscible organic solvents: alcohol solvents, such as methanol, ethanol, propanol, butanol, and isopropyl alcohol; ketone solvents, such as acetone, methyl ethyl ketone, and cyclohexanon; and glycol ether organic solvents, such as ethylene glycol (mono,di)methyl ether, ethylene glycol (mono,di)ethyl ether, ethylene glycol monopropyl ether, ethylene glycol monoisopropyl ether, monobutyl ether, diethylene glycol (mono,di)methyl ether, diethylene glycol (mono,di)ethyl ether, diethylene glycol monoisopropyl ether, diethylene glycol monobutyl ether, triethylene glycol (mono,di)methyl ether, propylene glycol (mono,di)methyl ether, propylene glycol monopropyl ether, propylene glycol monobutyl ether, and dipropylene glycol (mono,di)methyl ether. The above solvents may be used alone or in a mixture of two or more.

In consideration both work hygiene during printing and harmfulness of packaging materials, it is more preferable to use ethyl acetate, propyl acetate, isopropanol, n-propanol, or the like without using an aromatic solvent, such as toluene, or a ketone solvent, such as methyl ethyl ketone.

### (Other Additive)

The antiviral coating agent may further include a curing agent, a wax, a chelate crosslinking agent, an extender pigment, a leveling agent, an antifoaming agent, a plasticizer, an infrared absorber, an ultraviolet absorber, a fragrance agent, a flame retardant, and the like in order to impart intended fundamental physical properties to the antiviral coating agent.

### <Method for Producing Tannic Acid Derivative A>

The tannic acid derivative can be readily produced by, for example, reaction of the hydroxyl group of tannic acid with a compound including a group reactive with the hydroxyl group and an organic group having 1 to 18 carbon atoms. Specifically, the tannic acid derivative can be produced by reacting tannic acid with the above compound in a solvent, such as N-dimethylformamide (DMF) or N-methyl-2-pyrrolidone (NMP), in the presence of a basic catalyst. The group reactive with a hydroxyl group is not limited and may be any group capable of conducting the above reaction. Examples of such groups include a carboxyl group, a chlorocarbonyl group, a glycidyl group, and an isocyanate group. Examples of the compound including the group reactive with a hydroxyl group and the organic group having 1 to 18 carbon atoms include acrylic acid, (meth)acrylic acid, (meth)acryloyl chloride, glycidyl (meth)acrylate, isocyanatomethyl (meth)acrylate, and derivates thereof.

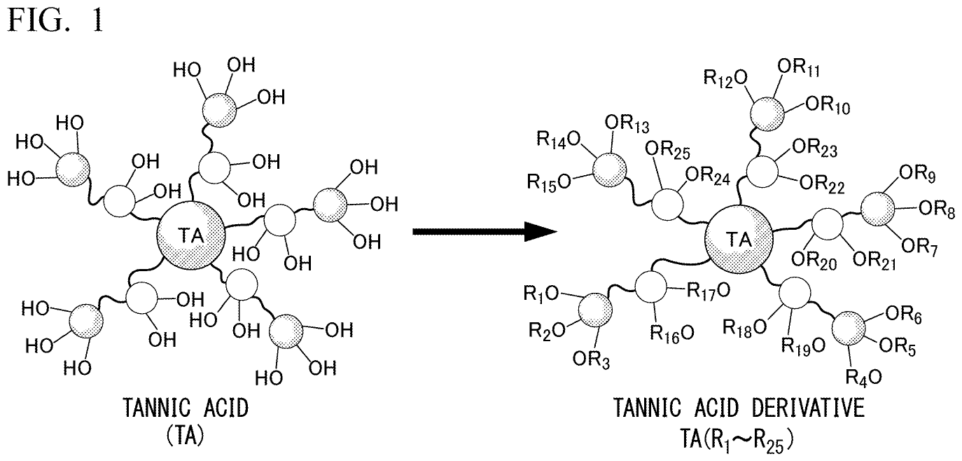

In the reaction, heating is performed at predetermined temperature for a predetermined amount of time which are publicly known and appropriate for the reactive group. FIG. 1 illustrates an example of derivatization of the tannic acid illustrated in Formula (2) below. The number of the organic groups having 1 to *18* carbon atoms (R₁ to R₂₅) which are introduced to the tannic acid can be set to an intended value by changing the molar ratio of the above compound to the tannic acid or the type of the above compound.

The reaction ratio between the tannic acid and the above compound is preferably Tannic acid:(Compound including group having active hydrogen reactive with hydroxyl group and organic group having 1 to 18 carbon atoms)=1:1 to 1:19 by mole. Note that, in the method for producing the tannic acid derivative, it is not necessary to introduce the above group to all of the plurality of molecules of the tannic acid used as a raw material; the above group may be introduced to a part of the plurality of molecules of the tannic acid used as a raw material, that is, one or more molecules of the tannic acid. In such a case, the number of the above groups introduced to one or more molecules may be one or two or more.

In the case where the above group is introduced to a part of the plurality of molecules of the tannic acid used as a raw material, that is, a plurality of molecules of the tannic acid, the types of the groups introduced to the respective molecules may be the same as or different from one another.

The tannic acid derivative A produced by the above method can be used as an antiviral agent or antiviral component, because the organic group having 1 to 18 carbon atoms makes the tannic acid derivative A readily soluble in solvents and, consequently, the tannic acid derivative A has a sufficiently high antiviral activity when included in the coating agent. In the case where the tannic acid derivative A is used as an antiviral component, an antiviral agent that includes the tannic acid derivative that serves as an antiviral component and one or more other components can be provided.

In the case where the tannic acid derivative A produced by the above method includes at least one group having an unsaturated double bond, it can be suitably used as an antiviral agent or an antiviral component, because the virus inactivation caused by the phenolic hydroxyl groups can be amplified by the unsaturated double bond. Examples of the group having an unsaturated double bond include an acryloyl group, a methacryloyl group, and an acetyl group. An acryloyl group is preferable in order to enhance antiviral activity.

The types of viruses to which the antiviral coating agent is targeted are not limited. Examples thereof include viruses having an envelope structure, such as an influenza virus, and viruses that do not have an envelope structure, such as norovirus. Examples of the viruses having an envelope structure include human or cattle pathogenic viruses, such as a human influenza virus, an avian influenza virus, herpes simplex virus type 1, Newcastle disease virus, and vesicular stomatitis virus, and fish disease viruses, such as viral haemorrhagic septicaemia virus.

In particular, when the tannic acid derivative A included in the antiviral coating agent includes an acryloyl group as a group having an unsaturated double bond, a suitable antiviral property can be produced against not only virus that do not have an envelope structure but also viruses having an envelope structure.

### <Method for Producing Antiviral Coating Agent>

The antiviral coating agent according to this embodiment can be produced by dissolving and/or dispersing the binder resin and the tannic acid derivative in an organic solvent. Examples of dispersers that can be used include a roller mill, a ball mill, a pebble mill, Attritor, and Sand Mill, which are commonly used in the related art.

### <Antiviral Agent>

The antiviral agent according to this embodiment includes a tannic acid derivative including at least one acryloyl group. Hereinafter, in this embodiment, the tannic acid derivative included in the antiviral agent is also referred to as “tannic acid derivative B”.

### (Tannic Acid Derivative B)

The tannic acid derivative B included in the antiviral agent has at least one or more acryloyl groups as described above. The average number of acryloyl groups included in a molecule of the tannic acid derivative B is preferably 1 to 38, is more preferably 1 to 34, and is further preferably 1 to 19 in order to further enhance virus inactivation.

The substitution ratio between tannic acid and the compound having an acryloyl group is preferably Tannic acid:(Compound including acryloyl group)=1:1 to 1:19 by mole.

Tannin is a generic name for plant-derived components that produce a polyhydric phenol by hydrolysis. Tannins can be classified roughly into hydrolyzable tannins, which are constituted by a sugar such as glucose and gallic acid or ellagic acid bonded to the sugar with an ester linkage and readily hydrolysable with an acid or enzyme, and condensed tannins, which are produced by polymerization of a compound having a flavanol skeleton.

It is considered that, regardless of whether any type of the above tannins or a mixture thereof is used, it can be converted into a derivative as described in the present disclosure and the advantageous effects of the present disclosure can be produced. A hydrolyzable tannin is preferable. For example, a compound including the tannic acid represented by Formula (2) below as a principal component is converted into a derivative.

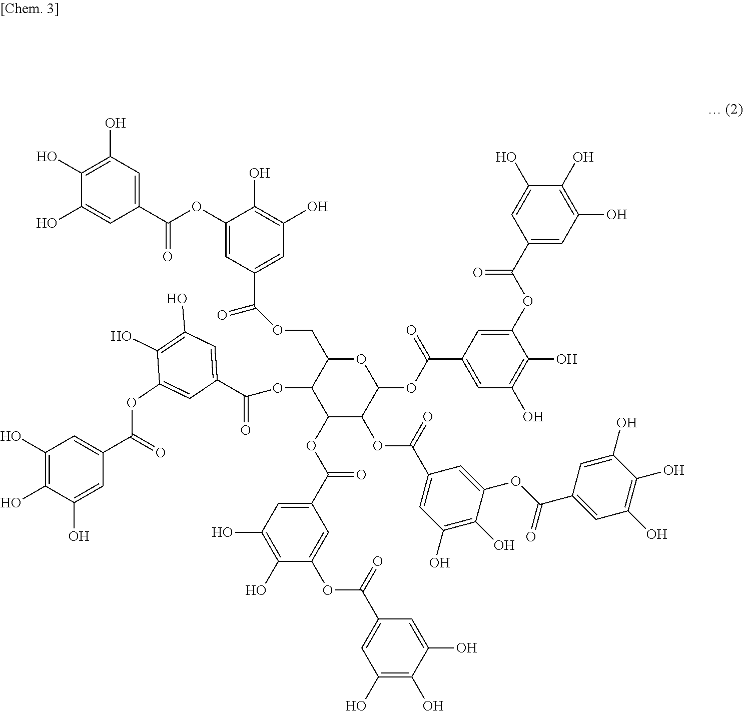 [SMILES: O=C(OCC1OC(OC(=O)c2cc(O)c(O)c(OC(=O)c3cc(O)c(O)c(O)c3)c2)C(OC(=O)c2cc(O)c(O)c(OC(=O)c3cc(O)c(O)c(O)c3)c2)C(OC(=O)c2cc(O)c(O)c(OC(=O)c3cc(O)c(O)c(O)c3)c2)C1OC(=O)c1cc(O)c(O)c(OC(=O)c2cc(O)c(O)c(O)c2)c1)c1cc(O)c(O)c(OC(=O)c2cc(O)c(O)c(O)c2)c1]

Tannic acid has a plurality of hydroxyl groups. In the tannic acid derivative B according to the present disclosure, hydrogen atoms of at least a part of the hydroxyl groups are replaced with a group including an acryloyl group. The total number of hydroxyl groups included in the tannic acid used as a raw material varies by the type of the tannic acid. For example, the total number of hydroxyl groups included in the tannic acid represented by Formula (2) above is 25, and one of the hydroxyl groups is substituted. Preferably, 1 to 19 hydroxyl groups are substituted on average.

The upper limit for the number of the substituents varies by the type of the substituents, the substrate used, and the intended purpose of use. In order to achieve a suitable antiviral property, a part of the hydroxyl groups may be substituted. In another case, all of the hydroxyl groups may be substituted.

The intrinsic antiviral property of tannic acid, that is, for example, inactivation of viruses having an envelope structure, can be achieved regardless of the type of the substituent introduced. On the other hand, an antiviral property which tannic acid does not have intrinsically, that is, for example, inactivation of viruses that do not have an envelope structure, is produced specifically when a specific substituent, that is, an acryloyl group, is introduced to tannic acid. Thus, the tannic acid derivative B according to this embodiment has an excellent antiviral property against viruses that do not have an envelope structure compared with tannic acid.

### <Method for Producing Tannic Acid Derivative B>

The tannic acid derivative can be readily produced by, for example, reaction of the hydroxyl group of tannic acid with a compound including a group reactive with the hydroxyl group and an acryloyl group. Specifically, the tannic acid derivative can be produced by reacting tannic acid with the above compound in a solvent such as methyl ethyl ketone (MEK) in the presence of a basic catalyst, such as triethylamine (TEA) (tertiary amine). The group reactive with the hydroxyl group is not limited and may be any group capable of conducting the above reaction. Examples of such groups include a carboxyl group, a chlorocarbonyl group, a glycidyl group, and an isocyanate group. Examples of the compound including a group reactive with a hydroxyl group and an acryloyl group include acrylic acid, acryloyl chloride, and derivates thereof.

In the reaction, heating is performed at predetermined temperature for a predetermined amount of time which are publicly known and appropriate for the reactive group. The number of the acryloyl groups introduced to the tannic acid can be set to an intended value by changing the molar ratio of the compound to the tannic acid or the type of the compound.

The reaction ratio between tannic acid and the compound is preferably Tannic acid:(Compound including group reactive with hydroxyl group and acryloyl group)=1:1 to 1:19 by mole. Note that, in the method for producing the tannic acid derivative, it is not necessary to introduce an acryloyl group to all of the plurality of molecules of the tannic acid used as a raw material; an acryloyl group may be introduced to a part of the plurality of molecules of the tannic acid used as a raw material, that is, one or more molecules of the tannic acid. In such a case, the number of acryloyl groups introduced to one or more molecules may be one or two or more.

In the case where the tannic acid derivative B produced by the above method includes at least one acryloyl group, it can be suitably used as an antiviral agent or an antiviral component, because the virus inactivation caused by the phenolic hydroxyl groups can be amplified by the acryloyl group. In the case where the tannic acid derivative is used as an antiviral component, an antiviral agent that includes the tannic acid derivative that serves as an antiviral component and one or more other components can be provided.

The viruses to which the antiviral agent is targeted are typically viruses that do not have an envelope structure, such as norovirus.

In particular, when the tannic acid derivative B included in the antiviral agent includes an acryloyl group as a group having an unsaturated double bond, a suitable antiviral property can be produced against not only virus that have an envelope structure but also viruses that do not have an envelope structure.

### <Laminated Body>

The laminated body according to this embodiment includes a substrate and a coat layer formed of the above antiviral coating agent. The laminated body may further include a sealing layer disposed on a side of the substrate which is opposite to the side on which the coat layer is disposed.

### [Coat Layer]

The coat layer is, for example, a layer formed of an antiviral coating agent that includes an organic solvent or the like as a solvent. As described above, this antiviral coating agent includes a tannic acid derivative including at least one organic group having 1 to 18 carbon atoms and a binder resin having a number-average molecular weight of 1,000 or more.

### [Sealing Layer]

The sealing layer is, for example, a layer formed of a sealing agent that includes an organic solvent or the like as a solvent. The sealing layer is not limited and may be any layer having a sealing property. For example, an adhesive film or sheet, such as a sticky film, a pressure-sensitive adhesive film, or a sealant film, may be used. For example, a coating layer formed of a coating agent having a sealing property which includes an organic solvent, an aqueous medium, or the like as a medium may be used.

The sealant film is preferably, for example, a polyethylene film, a polypropylene film, a polyolefin film composed of an ethylene-vinyl acetate copolymer or the like, or a film composed of an ionomer resin, an EAA resin, an EMAA resin, an EMA resin, an EMMA resin, a biodegradable resin, or the like.

Examples thereof include, in general names, a CPP (cast polypropylene) film, VMCPP (vacuum metallized cast polypropylene film), LLDPE (linear low-density polyethylene), LDPE (low-density polyethylene), HDPE (high-density polyethylene), a VMLDPE (vacuum metallized low-density polyethylene film) film, and the above films including a pigment. The surfaces of the above films may be subjected to various surface treatments, such as a flame treatment, a corona discharge treatment, and a chemical treatment using a primer or the like.

Among these, the coating layer formed of a coating agent having a sealing property is preferable because, as described below, the tannic acid derivative can be readily added to the coating layer. The resin included in the sealing layer may be selected from publicly known resins that have a sealing property.

### (Resin)

Examples of the resin that can be used include publicly known thermoplastic resins used for heat sealing or cold sealing. Specifically, thermoplastic resins having a softening temperature of at least 40° C. or more, which are not adhesive at temperatures equal to or less than room temperature, are preferable. Thermoplastic resins having a glass transition temperature of at least −10° C. or more are also preferable.

Examples of such thermoplastic resins include a polyester resin, a vinyl chloride resin, a vinyl chloride-vinyl acetate resin, an acrylic resin, a styrene-acrylic acid ester resin, a styrene-butadiene resin, a butadiene resin, a vinyl acetate resin, an ethylene-vinyl alcohol resin, an ethylene-acrylic acid ester resin, an ethylene-acrylic acid resin, an ethylene-vinyl acetate resin, a urethane resin, and a styrene-isoprene resin.

In particular, at least one resin selected from the group consisting of a urethane resin, an acrylic resin, a vinyl chloride-vinyl acetate copolymer resin, a polyester resin, an ethylene-vinyl acetate copolymer resin, and an ethylene-vinyl alcohol copolymer resin is preferable.

A composition that includes a main agent composed of a thermoplastic resin to which a reactive group, such as a hydroxyl group, a glycidyl group, or a carboxyl group, is grafted or bonded in a pendant manner in combination with a curing agent, such as an isocyanate curing agent or a polyamine curing agent, thermally reactive with the above reactive group can be used as a thermoplastic resin. Examples thereof include a combination of a main agent, such as a polyester-based resin to which the reactive group is grafted or bonded in a pendant manner, a polyether-based resin to which the reactive group is grafted or bonded in a pendant manner, a polyurethane-based resin to which the reactive group is grafted or bonded in a pendant manner, an epoxy resin to which the reactive group is grafted or bonded in a pendant manner, or a polyol-based resin to which the reactive group is grafted or bonded in a pendant manner, with a curing agent, such as an isocyanate or polyamine curing agent.

Specific examples thereof include a polyol such as polyethylene glycol, an acrylic polyol, a polyester polyol, a polyether polyol, a polyester polyether polyol, a polyester polyurethane polyol, a castor oil, a dehydrated castor oil, a castor wax, which is a hydrogenated caster oil, and a caster oil-based polyol, such as 5 to 50 mol alkylene oxide adduct of caster oil.

Examples of the curing agent include polyisocyanates having an aromatic structure in the molecular structure, such as tolylene diisocyanate, diphenylmethane diisocyanate, polymeric diphenylmethane diisocyanate, 1,5-naphthalene diisocyanate, triphenylmethane triisocyanate, and xylylene diisocyanate, and compounds produced by modifying a part of the NCO groups of the above polyisocyanates with a carbodiimide; allophanate compounds derived from the above polyisocyanates; polyisocyanates having an alicyclic structure in the molecular structure, such as isophorone diisocyanate, 4,4′-methylene bis(cyclohexyl isocyanate), and 1,3-(isocyanatomethyl)cyclohexane; linear aliphatic polyisocyanates, such as 1,6-hexamethylene diisocyanate, lysine diisocyanate, and trimethylhexamethylene diisocyanate, and allophanate compounds thereof; isocyanurate forms of the above polyisocyanates; allophanate forms derived from the above polyisocyanates; biuret forms derived from the above polyisocyanates; adduct forms modified with trimethylolpropane; and polyfunctional isocyanates, such as polyisocyanate, which are products of reaction of the various polyisocyanates described above with a polyol component, polyethylene polyamines, such as ethylenediamine, diethylenetriamine, triethylenetetramine, tetraethylenepentamine, pentaethylenehexamine, hexaethyleneheptamine, heptaethyleneoctamine, octaethylenenonamine, nonaethylenedecamine, piperazine, and N-aminoalkylpiperazine having an alkyl chain having 2 to 6 carbon atoms, and amine compounds such as 3-aminomethyl-3,5,5-trimethylcyclohexylamine (isophoronediamine, or IPDA).

### (Tannic Acid Derivative)

The sealing layer may include a tannic acid derivative including at least one organic group having 1 to 18 carbon atoms (i.e., the tannic acid derivative A). In other words, the coat layer disposed on a side of the substrate includes the tannic acid derivative including at least one organic group having 1 to 18 carbon atoms (i.e., the tannic acid derivative A), while the sealing layer disposed on the other side of the substrate may include the tannic acid derivative including at least one organic group having 1 to 18 carbon atoms (i.e., the tannic acid derivative A).

The sealing layer is preferably composed of an organic binder that includes the tannic acid derivative and the above resin. The organic binder is preferably composed of the tannic acid derivative and the resin.

The tannic acid derivative included in the sealing layer may be identical to or different from the tannic acid derivative included in the coat layer.

The content of the tannic acid derivative in the sealing layer is preferably 0.1% by mass or more and 50% by mass or less and is more preferably 0.5% by mass or more and 20% by mass or less.

The mass ratio between the tannic acid derivative and the resin that are included in the sealing layer is preferably 0.1:99.9 to 50:50 and is more preferably 0.5:99.5 to 20:80.

### [Substrate]

Examples of the substrate include, but are not limited to, a paper substrate, a plastic substrate, and a metal foil.

### (Paper Substrate)

The paper substrate is produced with a publicly known papermaking machine using a natural fiber for papermaking, such as a wood pulp. The papermaking conditions are not limited. Examples of the natural fiber for papermaking include wood pulps, such as a conifer wood pulp and a broadleaf wood pulp; non-wood pulps, such as a Manila hemp pulp, a sisal hemp pulp, and a flax pulp; and pulps produced by chemically modifying the above pulps. Examples of the types of pulps which can be used include a chemical pulp, a ground pulp, a chemiground pulp, and a thermomechanical pulp produced by sulfate cooking, acidic-neutral-alkaline sulfite cooking, soda salt cooking, or the like.

Various types of woodfree paper, coated paper, lined paper, impregnated paper, cardboard, paperboard, and the like which are commercially available may also be used.

### (Plastic Substrate)

The plastic substrate may be any substrate used as a substrate for a plastic material, a molded article, a film substrate, a packaging material, or the like. In particular, in the case where gravure roll coating (i.e., a gravure coater) or flexographic roll coating (i.e., a flexographic coater) is used, film substrates commonly used in the field of gravure or flexographic printing can be used directly.

Specific examples thereof include films composed of the following thermoplastic resins and laminated bodies including the films: polyamide resins, such as nylon 6, nylon 66, and nylon 46; polyester resins, such as polyethylene terephthalate (hereinafter, may be referred to as “PET”), polyethylene naphthalate, polytrimethylene terephthalate, polytrimethylene naphthalate, polybutylene terephthalate, and polybutylene naphthalate; polyhydroxycarboxylic acids, such as polylactic acid; biodegradable resins, such as aliphatic polyester resins (e.g., poly(ethylene succinate) and poly(butylene succinate)); polyolefin resins, such as polypropylene and polyethylene; and a polyimide resin, a polyarylate resin, and mixtures thereof. Among the above films, films composed of polyethylene terephthalate (PET), polyester, polyamide, polyethylene, and polypropylene can be suitably used. The above substrate film may be either unstretched or stretched. The method for producing the substrate film is also not limited. The thickness of the substrate film is also not limited and commonly 1 to 500 μm. The substrate film is preferably subjected to a corona discharge treatment. Aluminum, silica, alumina, or the like may be deposited on the substrate film by vapor deposition.

### (Metal Foil)

The type of the metal foil is not limited; various types of metal foils publicly known in the related art can be used. Examples of the metal material constituting the metal foil include aluminum, gold, silver, copper, a stainless steel, titanium, and nickel. Among these, a copper foil and an aluminum foil are preferable in consideration of simplicity of the production process and the production costs.

The substrate may also be a laminated body having a multilayer structure (may also be referred to as “laminated film”) produced by laminating the above paper or film substrates with one another by dry lamination, non-solvent lamination, or extrusion lamination. The structure of the laminated body may include a decorating layer, a varnish layer, and the like, such as a metal foil, a metal deposition film layer, an inorganic deposition film layer, an oxygen absorption layer, an anchor coat layer, and a print layer. There are various types of such laminated bodies depending on the applications. Examples of specific modes of the laminated film, which are the structures most widely used for food packages and daily necessities, include the following structures, where the paper or film substrate is expressed as (F), the print or varnish layer is expressed as (P), the metal or inorganic layer, such as a metal foil or a vapor deposition film layer, is expressed as (M), the adhesive layer is expressed as (AD), and the hot melt adhesive, the heat sealing agent, or the cold sealing agent is expressed as (AD2). It is needless to say that the structures are not limited to the following.
(F)/(P)/(F)
(F)/(P)/(AD)/(F),
(F)/(P)/(AD)/(F)/(AD)/(F), (F)/(P)/(AD)/(M)/(AD)/(F), (F)/(P)/(AD)/(M),
(F)/(P)/(AD)/(F)/(AD)/(M)/(AD)/(F), (F)/(P)/(AD)/(M)/(AD)/(F)/(AD)/(F), (M)/(P)/(AD)/(M),
(M)/(P)/(AD)/(F)/(AD)/(M), (P)/(F)
(P)/(F)/(P)
(P)/(F)/(AD)/(F),
(P)/(F)/(AD)/(F)/(AD)/(F)
(F)/(P)/(F)/(AD2)
(F)/(P)/(AD2)
(F)/(P)/(AD)/(M)/(AD2)

The single-layer paper or film substrate or the laminated body having a multilayer structure including a plurality of layers is referred to by various names depending on the industrial field and method of using the substrate, such as woodfree paper, coated paper, art paper, simili paper, thin paper, thick paper, and various types of synthetic paper, which are used as a functional film, a flexible packaging film, a shrink-wrapping film, a film for packaging daily necessities, a film for packaging drugs, a film for packaging foods, a carton, a poster, a handout, a CD wallet, a direct mail, a pamphlet, or a package for cosmetics and drinks, drugs, toys, instruments, or the like. The application of the coating agent is not limited. In this case, the coating agent is preferably applied onto the surface that serves as the uppermost layer of a container or packaging material that includes the coating agent.

### [Decorating Layer]

The laminated body according to this embodiment may include a decorating layer disposed on a side of the substrate which is opposite to the side on which the sealing layer is disposed. In this case, the coat layer may serve as a decorating layer, or a decorating layer other than the coat layer may be formed. In the case where the coat layer serves as a decorating layer, the decorating layer includes the above-described tannic acid derivative. In the case where a decorating layer other than the coat layer is formed, the decorating layer is, for example, interposed between the substrate and the coat layer.

The decorating layer may be a print layer including a printing ink. Examples of the type of the printing ink included in the print layer include, but are not limited to, an offset ink, a gravure printing ink, a flexographic printing ink, and an ink-jet printing ink.

### [Varnish Layer]

The laminated body according to this embodiment may further include a varnish layer disposed on a side of the substrate which is opposite to the side on which the sealing layer is disposed. In this case, the coat layer may serve as a varnish layer, or a varnish layer other than the coat layer may be formed. In the case where the coat layer serves as a varnish layer, the varnish layer includes the above-described tannic acid derivative. In the case where a varnish layer other than the coat layer is formed, the varnish layer is, for example, disposed on a side of the coat layer which is opposite to the side on which the substrate is disposed. In the case where the coat layer serves as a decorating layer, the varnish layer may be disposed on the decorating layer.

Examples of the type of varnish included in the varnish layer include, but are not limited to, an acrylic resin, a polyester resin, a urethane resin, cellulose, nitrocotton, and an amide.

### <Method for Producing Laminated Body>

The laminated body according to this embodiment can be produced by (1) applying the antiviral coating agent onto a surface of the substrate; and (2) drying the antiviral coating agent to form a coat layer.

Alternatively, the laminated body according to this embodiment may be produced by, for example, (1) applying the antiviral coating agent onto a surface of the substrate; (2) drying the antiviral coating agent to form a coat layer; (3) applying the sealing agent onto the other surface of the substrate; and (4) drying the agent to form a sealing layer.

In Step (1), the amount of the antiviral coating agent applied is preferably, but not limited to, 0.5 g/m² or more and 10 g/m² or less and is more preferably 1.0 g/m² or more and 5.0 g/m² or less.

In Step (3), the amount of the sealing agent applied is preferably, but not limited to, 1.0 g/m² or more and 10 g/m² or less and is more preferably 1.0 g/m² or more and 5.0 g/m² or less.

### [Sealing Agent]

The type of the sealing agent is not limited. The sealing agent includes any of the above-described publicly known resins having a sealing property and a medium. The sealing agent preferably includes any of the publicly known thermoplastic resins used for heat or cold sealing. A solvent such as an organic solvent or an aqueous medium can be used as a medium included in the sealing agent.

### (Solvent)

The organic solvent is added to the sealing agent in order to dilute the sealing agent and thereby increase ease of coating. Specific examples of solvents that can be used for dilution include toluene, xylene, methylene chloride, tetrahydrofuran, methanol, ethanol, isopropyl alcohol, methyl acetate, ethyl acetate, n-butyl acetate, acetone, methyl ethyl ketone (MEK), cyclohexanone, toluol, xylol, n-hexane, and cyclohexane, which have high solubility. In consideration of recent regulations on solvents, examples thereof include methanol, ethanol, isopropyl alcohol, methyl acetate, ethyl acetate, n-butyl acetate, acetone, methyl ethyl ketone (MEK), cyclohexanone, toluol, xylol, n-hexane, and cyclohexane. Among these, ethyl acetate and methyl ethyl ketone (MEK) are preferably used in consideration of solubility. Ethyl acetate is particularly preferable. It is possible to stabilize the solution at low temperature by using only the unregulated solvents. The amount of the organic solvent used is commonly about 20% by mass or more and 80% by mass or less, which varies by the required viscosity.

The sealing agent may include the tannic acid derivative including at least one organic group having 1 to 18 carbon atoms (i.e., the tannic acid derivative A). The content of the tannic acid derivative in the sealing agent is preferably, but not limited to, 0.1% by mass or more and 50% by mass or less and is more preferably 0.5% by mass or more and 20% by mass or less.

### (Method for Producing Sealing Agent)

In the case where the sealing agent includes the tannic acid derivative, the sealing agent can be produced by dissolving and/or dispersing the resin and the tannic acid derivative in a medium. Examples of dispersers that can be used include a roller mill, a ball mill, a pebble mill, Attritor, and Sand Mill, which are commonly used in the related art.

The method for producing the laminated body is not limited to Steps (1) to (4) above or the above-described order. For example, the antiviral coating agent may be applied onto a surface of the substrate, while the sealing agent is applied onto the other surface of the substrate (Steps (1) and (3)) and, subsequently, the antiviral coating agent and the sealing agent may be dried (Steps (2) and (4)).

In the case where the laminated body includes the decorating layer, the antiviral coating agent that forms the decorating layer may be applied to the substrate in Step (1). In the case where the laminated body includes a decorating layer other than the coat layer, a step of forming the decorating layer on a surface of the substrate may be conducted prior to Step (1). In such a case, the antiviral coating agent is applied to the decorating layer in the subsequent step, and the antiviral coating agent is dried.

In the case where the laminated body includes the varnish layer, an antiviral coating agent that forms the varnish layer may be applied to the substrate in Step (1). In the case where the laminated body includes a varnish layer other than the coat layer, a step of forming the varnish layer on the coat layer may be conducted subsequent to Step (1).

### [Specific Structures of Laminated Body and Package or Container]

FIGS. 2A and 2B are cross-sectional views of the laminated body according to this embodiment, illustrating examples of the specific structure of the laminated body.

As illustrated in FIG. 2A, a laminated body 10 includes a substrate 11, a coat layer 13 disposed on a side of the substrate 11, and a sealing layer 12A disposed on a side of the substrate 11 which is opposite to the side on which the coat layer 13 is disposed.

The coat layer 13 includes (1) a tannic acid derivative including at least one organic group having 1 to 18 carbon atoms (i.e., the tannic acid derivative A) and (2) a binder resin having a number-average molecular weight of 1000 or more. Hereinafter, a coat layer that includes the compounds (1) and (2) above is also referred to simply as “antiviral coat layer”.

In this embodiment, the antiviral coat layer 13 is disposed over the entire surface of the substrate 11 and located at the uppermost surface of the laminated body 10. The sealing layer 12A is disposed on a part of the surface of the substrate 11, that is, for example, on the outer periphery of the surface of the substrate 11, and can be used as a seal portion when the package described below is assembled.

As illustrated in FIG. 2B, the laminated body 10 may include a substrate 11, an antiviral coat layer 13 disposed on a side of the substrate 11, and a sealing layer 12B disposed on a side of the substrate 11 which is opposite to the side on which the coat layer 13 is disposed. The sealing layer 12B is disposed over the entire surface of the substrate 11, and a part (i.e., the outer periphery) of the sealing layer 12B can be used as a seal portion when the package described below is assembled.

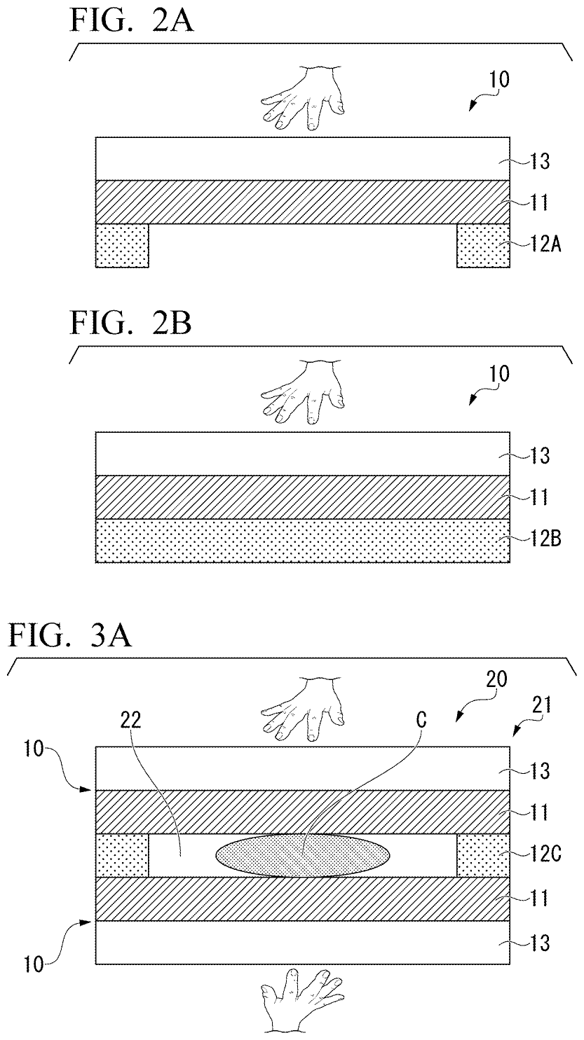

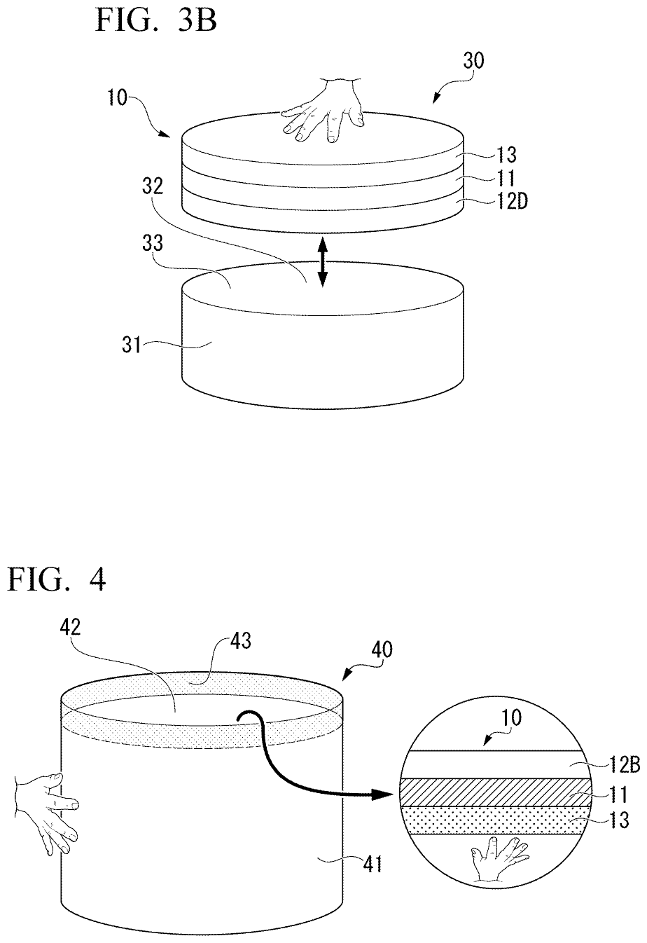

FIG. 3A is a cross-sectional view of a package including the laminated body 10 according to this embodiment, illustrating an example of the specific structure of the package.

As illustrated in FIG. 3A, a package 20 includes a housing 21 constituted by two laminated bodies 10 bonded to each other and an accommodation 22 formed inside the housing 21. The accommodation 22 is capable of accommodating contents C. The accommodation 22 accommodates foods, drugs, or the like. The accommodation 22 may include a gas, such as air. In another case, the inside of the accommodation 22 may be under reduced pressure, that is, for example, in vacuum.

The laminated bodies 10 each include a substrate 11, an antiviral coat layer 13 disposed on a side of the substrate 11, and a sealing layer 12C disposed on a side of the substrate 11 which is opposite to the side on which the antiviral coat layer 13 is disposed.

The sealing layer 12C is formed by, for example, two sealing layers 12A (FIG. 2A) formed on the respective laminated bodies 10 being bonded to each other. Note that the sealing layer 12A may be disposed on only one of the two laminated bodies 10; a sealing layer is not necessarily disposed on the other. In such a case, the sealing layer 12A disposed on one of the laminated bodies 10 forms the sealing layer 12C. When sealing is performed with the sealing layer 12C, the accommodation 22 can be isolated from the outside and the hermetically closed or sealed state of the accommodation 22 can be maintained.

In this embodiment, the antiviral coat layer 13 serves as an outermost layer of the package 20 and the above-described specific tannic acid derivative is held in the inside or surface of the resin included in the antiviral coat layer 13. According to this structure, even when viruses are adhered to the antiviral coat layer 13 when brought into contact with a human or the like, the antiviral coat layer 13 inhibits the growth of the viruses.

FIG. 3B is a perspective of a container including the laminated body 10 according to this embodiment, illustrating an example of the specific structure of the container.

As illustrated in FIG. 3B, a container 30 includes a container main body 31 and a laminated body 10 attached to the container main body 31.

The laminated body 10 includes a substrate 11, an antiviral coat layer 13 disposed on a side of the substrate 11, and a sealing layer 12D disposed on a side of the substrate 11 which is opposite to the side on which the antiviral coat layer 13 is disposed. The sealing layer 12D includes a tannic acid derivative including at least one organic group having 1 to 18 carbon atoms (i.e., the tannic acid derivative A). Hereinafter, a sealing layer that includes the specific tannic acid derivative is also referred to simply as “antiviral sealing layer”.

In this embodiment, the laminated body 10 serves as a lid for the container main body 31 and is attached to the container main body 31 so as to block an opening 32 of the container main body 31. When sealing is performed with the antiviral sealing layer 12D, internal space 33 can be isolated from the outside and the hermetically closed or sealed state of the internal space 33 can be maintained.

The antiviral sealing layer 12D serves as an innermost layer of the lid, and the above-described specific tannic acid derivative is held in the inside or surface of the resin included in the antiviral sealing layer 12D. According to this structure, even when the contents accommodated in the internal space 33 of the container main body 31, such as foods or drugs, are brought into contact with the antiviral sealing layer 12D, the antiviral sealing layer 12D inhibits the growth of the viruses in the package 20.

FIG. 4 is a perspective view of the package including the laminated body 10 according to this embodiment, illustrating another example of the specific structure of the package.

As illustrated in FIG. 4, a package 40 includes a housing 41 constituted by a plurality of laminated bodies 10 bonded to one another and an accommodation 42 formed inside the housing 41. The laminated bodies 10 each include a substrate 11, an antiviral coat layer 13 disposed on a side of the substrate 11, and a sealing layer 12B disposed on a side of the substrate 11 which is opposite to the side on which the antiviral coat layer 13 is disposed. The accommodation 42 is formed by, for example, the laminated body 10 located at the bottom and the laminated bodies located at the peripheral portion being bonded to one another.

The sealing layer 12B is disposed on a part of the surface of the substrate 11 and is located at an opening 43 of the housing 41. When contents are charged into the accommodation 42 of the package 40, the opening 43 is subsequently blocked, and heat sealing is performed with the sealing layers 12B being abutted to each other, the accommodation 42 can be isolated from the outside and the hermetically closed or sealed state of the accommodation 42 can be maintained.

In this embodiment, the antiviral coat layer 13 serves as an outermost layer of the package 40 and the above-described specific tannic acid derivative is held in the inside or surface of the resin included in the antiviral coat layer 13. According to this structure, the antiviral coat layer 13 inhibits the growth of the viruses.

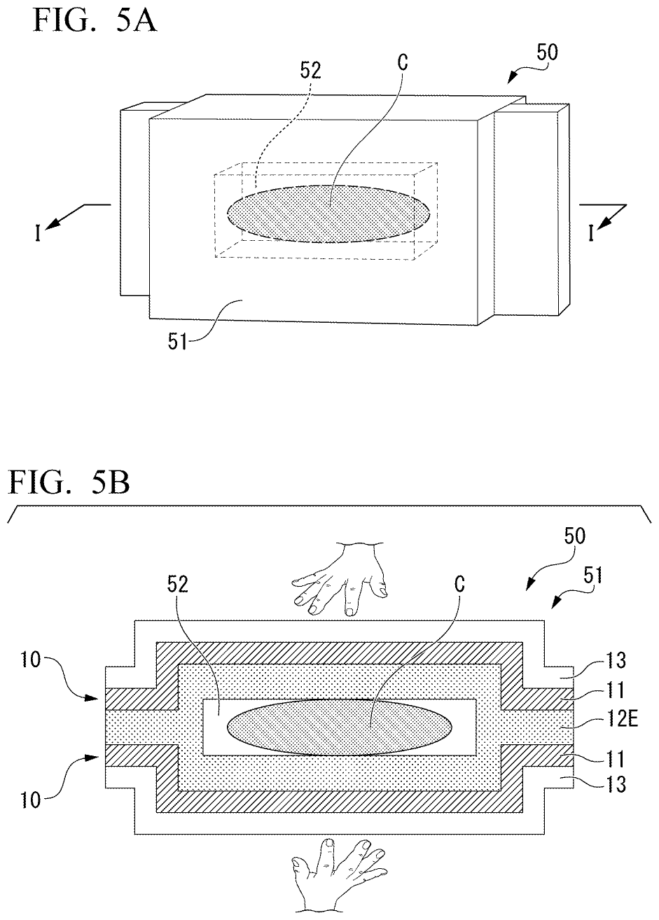

FIG. 5A is a perspective view of the package including the laminated body 10 according to this embodiment, illustrating another example of the specific structure of the package. FIG. 5B is a cross-sectional view taken along Line I-I of FIG. 5A.

As illustrated in FIGS. 5A and 5B, a package 50 includes a housing 51 constituted by two laminated bodies 10 bonded to each other and an accommodation 52 formed inside the housing 21. The accommodation 52 is capable of accommodating contents C. The accommodation 52 accommodates foods, drugs, or the like. The accommodation 52 may include a gas, such as air. In another case, the inside of the accommodation 52 may be under reduced pressure, that is, for example, in vacuum.

The laminated bodies 10 each include a substrate 11, an antiviral coat layer 13 disposed on a side of the substrate 11, and an antiviral sealing layer 12E disposed on a side of the substrate 11 which is opposite to the side on which the antiviral coat layer 13 is disposed.

The antiviral sealing layer 12E is formed by, for example, two sealing layers 12A (FIG. 2B) formed on the respective laminated bodies 10 being bonded to each other. Note that the sealing layer 12A may be disposed on only one of the two laminated bodies 10; a sealing layer is not necessarily disposed on the other. In such a case, the sealing layer 12A disposed on one of the laminated bodies 10 forms the antiviral sealing layer 12E. When sealing is performed with the antiviral sealing layer 12E, the accommodation 52 can be isolated from the outside and the hermetically closed or sealed state of the accommodation 52 can be maintained.

The antiviral coat layer 13 serves as an outermost layer of the package 50 and the above-described specific tannic acid derivative is held in the inside or surface of the resin included in the antiviral coat layer 13.

According to this structure, the antiviral coat layer 13 inhibits the growth of the viruses, and the antiviral sealing layer 12E also inhibits the growth of the viruses inside the package 20.

The antiviral coat layer 13 may serve as a decorating layer or varnish layer. This inhibits the growth of viruses and allows simplification of the layer structure, which results in a reduction in the weight of the package and reductions in costs.

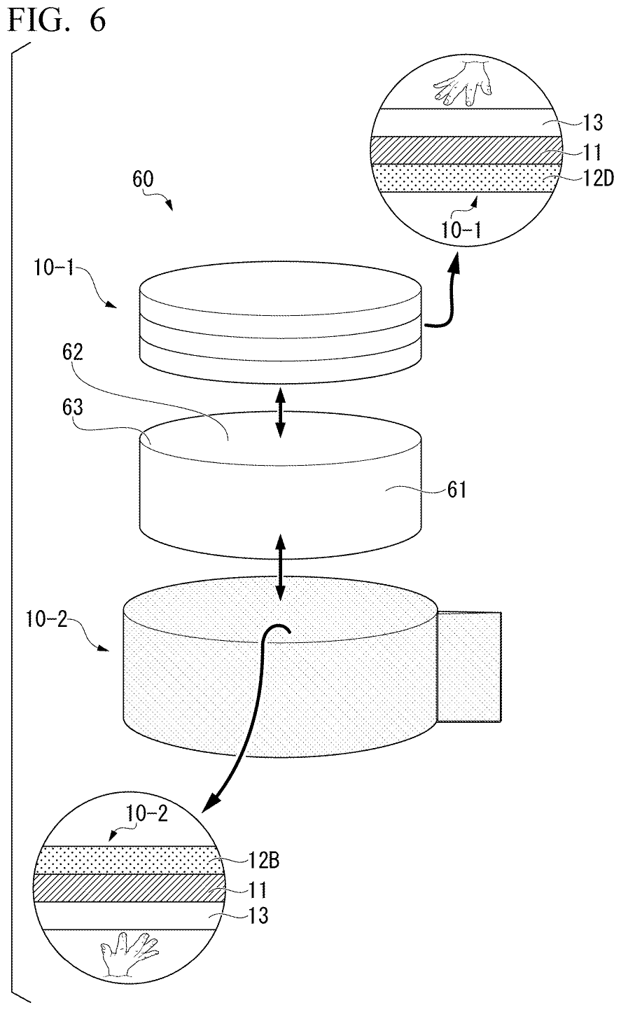

FIG. 6 is a perspective of a container including the laminated body 10 according to this embodiment, illustrating another example of the specific structure of the container.

As illustrated in FIG. 6, a container 60 includes a container main body 61 and two laminated bodies 10-1 and 10-2 that are attached to the container main body 31.

The laminated body 10-1 includes a substrate 11, an antiviral coat layer 13 disposed on a side of the substrate 11, and an antiviral sealing layer 12D disposed on a side of the substrate 11 which is opposite to the side on which the antiviral coat layer 13 is disposed. The laminated body 10-1 serves as a lid for the container main body 61 and is attached to the container main body 61 so as to block an opening 62 of the container main body 61. When sealing is performed with the antiviral sealing layer 12D, internal space 63 can be isolated from the outside and the hermetically closed or sealed state of the internal space 63 can be maintained.

The antiviral coat layer 13 of the laminated body 10-1 serves as an outermost layer of the container 60, and the above-described specific tannic acid derivative is held in the inside or surface of the resin included in the antiviral coat layer 13. The antiviral sealing layer 12D serves as an innermost layer of the container 60, and the above-described specific tannic acid derivative is held in the inside or surface of the resin included in the antiviral sealing layer 12D.

The laminated body 10-2 includes a substrate 11, an antiviral coat layer 13 disposed on a side of the substrate 11, and a sealing layer 12B disposed on a side of the substrate 11 which is opposite to the side on which the antiviral coat layer 13 is disposed. The laminated body 10-2 is attached onto the outer surface of the container main body 61, that is, for example, onto the outer peripheral surface of the container main body 61. The antiviral coat layer 13 of the laminated body 10-2 serves as an outermost layer of the container 60, and the above-described specific tannic acid derivative is held in the inside or surface of the resin included in the antiviral coat layer 13.

According to this structure, the antiviral coat layers 13 included in the laminated bodies 10-1 and 10-2 inhibit the growth of the viruses, and the antiviral sealing layer 12D also inhibits the growth of the viruses inside the container 60.

### EXAMPLES

Examples of the present invention are described below. It should be noted that the present invention is not limited by Examples below. In Examples, the units of values listed in the tables are percent by mass unless otherwise specified. The raw materials used were reagent grade unless otherwise specified.

### Synthesis Example 1

A reflux tube, a stirrer, a dropping funnel, and a nitrogen purge tube were attached to a flask. To the flask, 300 mL of N-dimethylformamide (hereinafter, referred to as “DMF”) was charged. While the flask was cooled with ice, N-methyl-2-pyrrolidone (NMP) was stirred and 100 g (59 mmol) of tannic acid and 32 mL (226 mmol) of triethylamine were charged into the flask to form a solution. After dissolution had been confirmed, 17 mL (206 mmol) of acryloyl chloride was gradually added to the flask through the dropping funnel, and the resulting mixture was stirred for 1 hour. Then, after the ice bath had been removed, stirring was performed for 72 hours at room temperature.

After the reaction had been completed, 500 mL of ion water, 500 mL of an saturated aqueous sodium chloride (hereinafter, referred to as “NaCl”) solution, and 50 mL of tetrahydrofuran (hereinafter, referred to as “THF”) were added to the reaction mixture. The resulting two-phase solution was stirred until all the solid substances had been dissolved. After stirring had been finished, the flask was left to stand in order to cause phase separation. The organic phase was taken from the flask with a separating funnel and cleaned 3 times with a liquid mixture of 500 mL of THF and 500 mL of a saturated aqueous NaCl solution. The organic phase was subsequently cleaned once with 1000 mL of a saturated aqueous NaCl solution. The resulting organic solution was dehydrated using magnesium sulfate (hereinafter, referred to as “MgSO₄”). After MgSO₄ had been removed by filtering, the organic layer was concentrated under reduced pressure to form a coarse solid. This crude product was dissolved in 70 mL of THF. The resulting mixed solution was charged into 1400 mL of chloroform charged in a flask while stirred. After the flask had been left to stand a night, solid substances were removed by filtering under reduced pressure. The resulting product was dried at 60° C. for 24 hours under reduced pressure. Hereby, 36 g (yield: 86%) of a product 1 (acryloyl group-containing tannic acid 1) was prepared. The ratio (molar ratio) of the OH groups substituted with acryloyl groups which was determined by 1H-NMR measurement was 11%.

### Synthesis Example 2

As in Synthesis Example 1, a reflux tube, a stirrer, a dropping funnel, and a nitrogen purge tube were attached to a flask. To the flask, 300 mL of NMP was charged. While the flask was cooled with ice, NMP was stirred and 30 g (18 mmol) of tannic acid and 32 mL (226 mmol) of triethylamine were charged into the flask to form a solution. After dissolution had been confirmed, 10 mL (123 mmol) of acryloyl chloride was gradually added to the flask through the dropping funnel, and the resulting mixture was stirred for 1 hour. Then, after the ice bath had been removed, stirring was performed for 72 hours at room temperature.

After the reaction had been completed, 500 mL of ion water, 500 mL of an saturated aqueous NaCl solution, and 50 mL of THF were added to the reaction mixture. The resulting two-phase solution was stirred until all the solid substances had been dissolved. After stirring had been finished, the flask was left to stand in order to cause phase separation. The organic phase was taken from the flask with a separating funnel and cleaned 3 times with a liquid mixture of 500 mL of THF and 500 mL of a saturated aqueous NaCl solution. The organic phase was subsequently cleaned once with 1000 mL of a saturated aqueous NaCl solution. The resulting organic solution was dehydrated using MgSO₄. After MgSO₄ had been removed by filtering, the organic layer was concentrated under reduced pressure to form a coarse solid. This crude product was dissolved in 70 mL of THF. The resulting mixed solution was charged into 1000 mL of chloroform charged in a flask while stirred. After the flask had been left to stand a night, solid substances were removed by filtering under reduced pressure. The resulting product was dried at 60° C. for 24 hours under reduced pressure. Hereby, 26 g (yield: 74%) of a product 2 (acryloyl group-containing tannic acid 2) was prepared. The ratio (molar ratio) of the OH groups substituted with acryloyl groups which was determined by 1H-NMR measurement was 23%.

### Synthesis Example 3

As in Synthesis Example 1, a reflux tube, a stirrer, a dropping funnel, and a nitrogen purge tube were attached to a flask. To the flask, 300 mL of NMP was charged. While the flask was cooled with ice, NMP was stirred and 100 g (59 mmol) of tannic acid and 32 mL (226 mmol) of triethylamine were charged into the flask to form a solution. After dissolution had been confirmed, 11.8 mL (123 mmol) of methacryloyl chloride was gradually added to the flask through the dropping funnel, and the resulting mixture was stirred for 1 hour. Then, after the ice bath had been removed, stirring was performed for 72 hours at room temperature.

After the reaction had been completed, 500 mL of ion water, 500 mL of an saturated aqueous NaCl solution, and 50 mL of THF were added to the reaction mixture. The resulting two-phase solution was stirred until all the solid substances had been dissolved. After stirring had been finished, the flask was left to stand in order to cause phase separation. The organic phase was taken from the flask with a separating funnel and cleaned 3 times with a liquid mixture of 500 mL of THF and 500 mL of a saturated aqueous NaCl solution. The organic phase was subsequently cleaned once with 1000 mL of a saturated aqueous NaCl solution. The resulting organic solution was dehydrated using MgSO₄. After MgSO₄ had been removed by filtering, the organic layer was concentrated under reduced pressure to form a coarse solid. This crude product was dissolved in 70 mL of THF. The resulting mixed solution was charged into 5000 mL of chloroform charged in a flask while stirred. After the flask had been left to stand a night, solid substances were removed by filtering under reduced pressure. The resulting product was dried at 60° C. for 24 hours under reduced pressure. Hereby, 27 g (yield: 70%) of a product 3 (methacryloyl group-containing tannic acid 3) was prepared. The ratio (molar ratio) of the OH groups substituted with methacryloyl groups which was determined by 1H-NMR measurement was 10%.

### Synthesis Example 4

A reflux tube, a stirrer, a dropping funnel, and a nitrogen purge tube were attached to a flask. To the flask, 80 mL of methyl ethyl ketone (hereinafter, referred to as “MEK”) was charged. While MEK was stirred, 100 g (59 mmol) of tannic acid was dissolved therein at room temperature. Subsequently, the temperature was increased to 70° C. and the nitrogen purge tube was replaced with an air purge tube. Then, 42 g (295 mL) of 2-acryloyloxyethyl isocyanate (“Karenz AOI” produced by SHOWA DENKO K.K.) was added dropwise to the flask through the dropping funnel over 1 hour. After stirring had been performed at 70° C. for 72 hours, the reaction solution was cooled to room temperature and concentrated under reduced pressure to form a coarse solid.

This crude product was dissolved in 70 mL of THF. The resulting mixed solution was charged into 1000 mL of dichloromethane charged in a flask while stirred. After the flask had been left to stand a night, solid substances were removed by filtering under reduced pressure. The resulting product was dried at 80° C. for 12 hours under reduced pressure. Hereby, 121 g (yield: 85%) of a product 4 (acryloyl urethane-modified tannic acid 4) was prepared. The ratio (molar ratio) of the OH groups substituted with acryloyl groups which was determined by 1H-NMR measurement was 10%.

### Synthesis Example 5

As in Synthesis Example 1, a reflux tube, a stirrer, a dropping funnel, and a nitrogen purge tube were attached to a flask. To the flask, 1000 mL of acetone was charged. While the flask was cooled with ice, acetone was stirred and 100 g (59 mmol) of tannic acid and 90 mL (647 mmol) of triethylamine were charged into the flask to form a solution. After dissolution had been confirmed, 42 mL (588 mmol) of acetyl chloride was gradually added to the flask through the dropping funnel, and the resulting mixture was stirred for 1 hour. Then, after the ice bath had been removed, stirring was performed for 20 hours at room temperature.

After the reaction had been completed, 2000 mL of ion water, 500 mL of an saturated aqueous NaCl solution, and 50 mL of THF were added to the reaction mixture. The resulting two-phase solution was stirred until all the solid substances had been dissolved. After stirring had been finished, the flask was left to stand in order to cause phase separation. The organic phase was taken from the flask with a separating funnel and cleaned 3 times with a liquid mixture of 500 mL of THF and 500 mL of a saturated aqueous NaCl solution. The organic phase was subsequently cleaned once with 1000 mL of a saturated aqueous NaCl solution. The resulting organic solution was dried on MgSO₄. After MgSO₄ had been removed by filtering, concentration was performed under reduced pressure to form a coarse solid. This crude product was dissolved in 70 mL of THF. The resulting mixed solution was charged into 1000 mL of dichloromethane charged in a flask while stirred. After the flask had been left to stand a night, solid substances were removed by filtering under reduced pressure. The resulting product was dried at 80° C. for 12 hours under reduced pressure. Hereby, 88.9 g (yield: 86%) of a product 5 (acetyl group-containing tannic acid 5) was prepared. The ratio (molar ratio) of the OH groups substituted with acetyl groups which was determined by 1H-NMR measurement was 10%.

### Reference Example 1

Tannic acid was used as a compound of Reference Example 1.

### Examples 1 to 5: Antiviral Agent

The compounds prepared in Synthesis Examples 1 to 5 as products 1 to 5 were each dissolved in MEK to prepare antiviral agents 1 to 5 having a solid content of 40%.

### Comparative Example 1: Antiviral Agent

The compound of Reference Example 1 was dissolved in MEK as in Examples 1 to 5 to prepare an antiviral agent 6 having a solid content of 40%.

### Examples 6 to 10: Antiviral Coating Agent

The products 1 to 5 prepared in Synthesis Examples 1 to 5 were each dissolved in an ethyl acetate solution of a polyester resin (“VYLON GK-880” produced by Toyobo Co., Ltd.) at a solid content of 10% to prepare antiviral coating agents 1 to 5. The number-average molecular weight of the polyester resin used in Examples 6 to 10 was 5,000.

### Comparative Example 2: Coating Agent

The compound of Reference Example 1 was dissolved in an ethyl acetate solution of a polyester resin (“VYLON GK-880” produced by Toyobo Co., Ltd.) at a solid content of 10% as in Examples 1 to 5 to prepare a coating agent 6.

### Comparative Example 3: Coating Agent

A coating agent 7 was prepared by dissolving a polyester resin (“VYLON GK-880” produced by Toyobo Co., Ltd.) in ethyl acetate as in Comparative Example 2, except that the compound of Reference Example 1 was not used.

### (Method for Preparing Antiviral Substrate)

The substrates used were polyethylene terephthalate (hereinafter, referred to as “PET”) films having a thickness of 15 μm. The antiviral coating agents 1 to 5 prepared in Examples 1 to 5 and the coating agents 6 and 7 prepared in Comparative Example 2 and 3 were applied to the respective substrates such that the amount of the coating agent deposited on each substrate was 5 g/m² (solid content). The organic solvent was removed at 80° C. for 2 minutes by volatilization. Hereby, antiviral substrates (laminated bodies) were prepared.

### (Antiviral Testing Method)

As antiviral tests, a bacteriophage Qβ test described in JIS R 1756, which is targeted to viruses that do not have an envelope structure, and a bacteriophage φ6 test targeted to viruses that have an envelope structure, which is not described in but conforms to the standard, were conducted. Both tests were conducted for two hours. In the above tests, reductions in the amounts of viruses relative to the initial state were determined. As for the evaluation standard, an evaluation grade of “Excellent” was given when the antiviral activity value was 3 or more, an evaluation grade of “Good” was given when the antiviral activity value was 2 or more and less than 3, an evaluation grade of “Slightly Poor” was given when the antiviral activity value was 1 or more and less than 2, and an evaluation grade of “Poor” was given when the antiviral activity value was less than 1. It is considered that antiviral activity was confirmed when the antiviral activity value was 2 or more. Table 1 lists the results.

TABLE 1

| | | | | | | | | Comparative |
|---|---|---|---|---|---|---|---|---|
| | Type of | Proportion | Example 1 | Example 2 | Example 3 | Example 4 | Example 5 | Example 1 |
| Name of raw | unsaturated | of OH groups | Antiviral | Antiviral | Antiviral | Antiviral | Antiviral | Antiviral |
| material | double bond group | replaced (%) | agent 1 | agent 2 | agent 3 | agent 4 | agent 5 | agent 6 |
| Product 1 | Acryloyl group | 11 | 40 | | | | | |
| Product 2 | Acryloyl group | 23 | | 40 | | | | |
| Product 3 | Methacryloyl group | 10 | | | 40 | | | |
| Product 4 | Acryloyl group | 10 | | | | 40 | | |
| Product 5 | Acetyl group | 10 | | | | | 40 | |
| Tannic acid | Tannic acid | 20 | | | | | | 40 |
| Polyester resin | | | | | | | | |
| Methyl ethyl | | | 60 | 60 | 60 | 60 | 60 | 60 |
| ketone | | | | | | | | |
| Ethyl acetate | | | | | | | | |

| | | | | | | |
|---|---|---|---|---|---|---|
| Qβ test | Excellent | Excellent | Good | Excellent | Good | Good |
| φ6 test | Excellent | Excellent | Excellent | Excellent | Excellent | Excellent |

TABLE 2

| | Type of | | Example 6 | Example 7 | Example 8 | Example 9 | Example 10 | Comparative | Comparative |
|---|---|---|---|---|---|---|---|---|---|
| | unsaturated | Proportion | Antiviral | Antiviral | Antiviral | Antiviral | Antiviral | Example 2 | Example 3 |
| Name of raw | double bond | of OH groups | coating | coating | coating | coating | coating | Coating | Coating |
| material | group | replaced (%) | agent 1 | agent 2 | agent 3 | agent 4 | agent 5 | agent 8 | agent 7 |
| Product 1 | Acryloyl group | 11 | 4 | | | | | | |
| Product 2 | Acryloyl group | 23 | | 4 | | | | | |
| Product 3 | Methacryloyl | 10 | | | 4 | | | | |
| | group | | | | | | | | |
| Product 4 | Acryloyl group | 10 | | | | 4 | | | |
| Product 5 | Acetyl group | 10 | | | | | 4 | | |
| Tannic acid | Tannic acid | 0 | | | | | | 4 | |
| Polyester resin | | | 36 | 36 | 36 | 36 | 36 | 36 | 40 |
| Methyl ethyl | | | | | | | | | |
| ketone | | | | | | | | | |
| Ethyl acetate | | | 60 | 60 | 60 | 60 | 60 | 60 | 60 |

| | | | | | | | |
|---|---|---|---|---|---|---|---|
| Qβ test | 5.3 | 5.3 | 2 | 5.3 | 2 | <1 | <1 |
| | Excellent | Excellent | Good | Excellent | Good | Poor | Poor |
| Qβ test | 5.4 | 5.4 | 5.4 | 5.4 | 5.4 | <1 | <1 |
| | Excellent | Excellent | Excellent | Excellent | Excellent | Poor | Poor |

The results listed in Table 1 confirm that, in Examples 1, 2, and 4, where the antiviral agents 1, 2, and 4 that included tannic acid derivatives having an acryloyl group were used, the activity values measured in the bacteriophage Qβ test were 3 or more. That is, a high antiviral activity against viruses that do not have an envelope structure was confirmed.

In Example 3, where the antiviral agent 3 that included a tannic acid derivative including a methacryloyl group was used, a high antiviral activity against viruses that have an envelope structure was confirmed in the bacteriophage φ6 test, while a low antiviral activity against viruses that do not have an envelope structure was confirmed in the bacteriophage Qβ test.

In Example 5, where the antiviral agent 5 that included a tannic acid derivative including an acetyl group was used, a high antiviral activity was confirmed in the bacteriophage φ6 test as in Example 4, while a low antiviral activity was confirmed in the bacteriophage Qβ test.

The results listed in Table 2 confirm that, in Examples 6 to 10, where the antiviral coating agents 1 to 5 that included the antiviral agents 1 to 5 were used for antiviral substrates, antiviral activity values determined in the bacteriophage φ6 test were 3 or more. That is, a high antiviral activity against viruses that have an envelope structure was confirmed.

Furthermore, in Examples 6, 7, and 9, where the antiviral coating agents 1, 2, and 4 that included the antiviral agents 1, 2, and 4 were used for antiviral substrates, antiviral activity values determined in the bacteriophage Qβ test were 3 or more. That is, a high antiviral activity against viruses that do not have an envelope structure was also confirmed.

On the basis of the above facts, it is considered that adding a tannic acid derivative including a group having an unsaturated double bond, such as an acryloyl group, a methacryloyl group, or an acetyl group, to an antiviral coating agent made the tannic acid derivative readily soluble in low-polarity solvents, such as ethyl acetate, and consequently allowed the tannic acid derivative to rise to the surface of the coating film and produce a suitable antiviral activity.

In contrast, in Comparative Example 2, where the coating agent 6 that included the antiviral agent 6 that was tannic acid was used for an antiviral substrate, the antiviral activity value determined in the bacteriophage φ6 test was less than 1. That is, an antiviral activity against viruses that do not have an envelope structure was not produced. Moreover, the antiviral activity value determined in the bacteriophage Qβ test was less than 1. That is, an antiviral activity against viruses that have an envelope structure was also not produced.

In Comparative Example 3, where the coating agent 7 that did not include any antiviral agent was used for an antiviral substrate, the antiviral activity value determined in the bacteriophage φ6 test was less than 1 similarly to Comparative Example 2. That is, an antiviral activity against viruses that do not have an envelope structure was not produced. Moreover, the antiviral activity value determined in the bacteriophage Qβ test was less than 1. That is, an antiviral activity against viruses that have an envelope structure was also not produced.

On the basis of the above facts, it is considered that the tannic acid used in Comparative Example 2 did not rise to the surface of the coating film and did not produce an antiviral activity because it is soluble in polar solvents, such as NPM or MEK, but insoluble in low-polarity solvents, such as ethyl acetate.

### REFERENCE SIGNS LIST

10 LAMINATED BODY
10-1 LAMINATED BODY
10-2 LAMINATED BODY
11 SUBSTRATE
12A SEALING LAYER
12B SEALING LAYER
12C SEALING LAYER
12D SEALING LAYER (ANTIVIRAL SEALING LAYER)
12E SEALING LAYER (ANTIVIRAL SEALING LAYER)
13 COAT LAYER (ANTIVIRAL COAT LAYER)
20 PACKAGE
21 HOUSING
22 ACCOMMODATION
30 CONTAINER
31 CONTAINER MAIN BODY
32 OPENING
33 INTERNAL SPACE
40 PACKAGE
41 HOUSING
42 ACCOMMODATION
43 OPENING
50 PACKAGE
51 HOUSING
52 ACCOMMODATION
60 CONTAINER
61 CONTAINER MAIN BODY
62 OPENING
63 INTERNAL SPACE

1. An antiviral coating agent comprising a tannic acid derivative including at least one organic group having 1 to 18 carbon atoms, and a binder resin having a number-average molecular weight of 1,000 or more.

2. The antiviral coating agent according to claim 1, wherein the organic group has one or more structures selected from the group consisting of a group having an unsaturated double bond between carbon atoms, a group having an unsaturated double bond between oxygen and carbon atoms, and an alkyl group.

3. The antiviral coating agent according to claim 1, wherein an average number of the organic groups included in a molecule of the tannic acid derivative is 1 to 38.

4. The antiviral coating agent according to claim 1, represented by Formula (1) below. 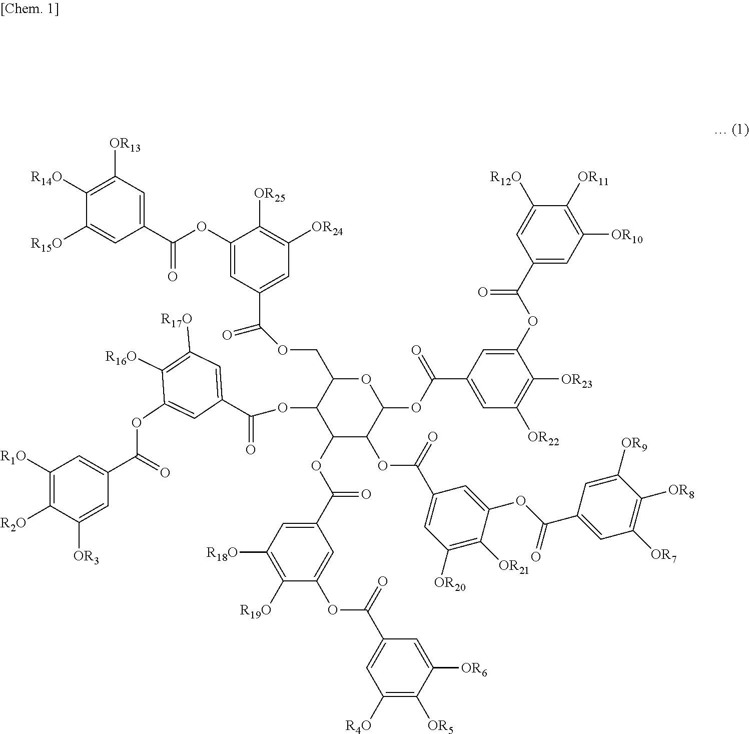
{In General Formula (1), R₁ to R₂₅ each independently represent (excluding the case where R₁ to R₂₅ all represent a hydrogen atom) a group selected from the group consisting of a hydrogen atom, —C(═O)—CH═CH₂, —C(═O)—C(CH₃)═CH₂, —C(═O)N—CH═CH₂, —C(═O)N—C(CH₃)═CH₂, —C(—OH)—CH═CH₂, —C(—OH)—C(CH₃)═CH₂, —C(═O)N—(CH₂)₂—CH═CH₂, —C(═O)N—(CH₂)₂—C(CH₃)═CH₂, —C((═O)N—C((CH₂)₂—CH═CH₂)₂, —C(═O)—R₂₆, and —R₂₆ (where R₂₆ represents a hydrocarbon having 1 to 18 carbon atoms)}

5. A laminated body comprising a substrate and a coat layer including the antiviral coating agent according to claim 1.

6. The laminated body according to claim 5, wherein the coat layer serves as a decorating layer.

7. The laminated body according to claim 6, wherein the decorating layer includes a print layer including a printing ink.

8. The laminated body according to claim 5, wherein the coat layer is a layer formed of a coating agent having a sealing property.

9. The laminated body according to claim 5, further comprising a sealing layer disposed on a side of the substrate, the side being opposite to a side on which the coat layer is disposed,
wherein the sealing layer includes a tannic acid derivative including at least one organic group having 1 to 18 carbon atoms.

10. The laminated body according to claim 9, wherein the sealing layer includes the tannic acid derivative and a binder resin.

11. A package or container comprising a container main body and one or more laminated bodies according to claim 5, the one or more laminated bodies being attached to the container main body.

12. The package or container according to claim 11, wherein the laminated body serves as a lid for the container main body.

13. The package or container according to claim 11, wherein the laminated body is attached onto an outer surface of the container main body.

14. A package or container comprising a housing including one or more laminated bodies according to claim 5, the one or more laminated bodies being bonded to one another, and an accommodation formed inside the housing.

15. An antiviral agent comprising a tannic acid derivative including at least one acryloyl group.

16. The antiviral agent according to claim 15, capable of inactivating a virus that does not have an envelope structure.
